(19) United States
(12) Patent Application Publication
(10) Pub. No.: US 2025/0256207 A1
(43) Pub. Date: Aug. 14, 2025

(54) DISPLAYING LEVELS OF DETAIL OF 2D AND 3D OBJECTS IN VIRTUAL SPACES

(71) Applicant: Roblox Corporation, San Mateo, CA (US)

(72) Inventors: Mohammed Younes HAMDOUD, San Mateo, CA (US); Morgan Samuel MCGUIRE, Victoria, BC (CA)

(73) Assignee: Roblox Corporation, San Mateo, CA (US)

(21) Appl. No.: 18/440,267

(22) Filed: Feb. 13, 2024

(51) Int. Cl. A63F 13/525

(52) U.S. Cl. CPC A63F 13/525

(57) ABSTRACT

Displaying levels of detail of 2D and 3D objects in virtual spaces. In some implementations, a computer-implemented method includes causing a graphical object to be displayed in a virtual space, and determining that the graphical object straddles a transition boundary in the virtual space, the transition boundary having a location relative to a virtual camera. If the graphical object straddles the transition boundary, a corresponding object is displayed with a different number of spatial dimensions in the virtual space than the graphical object and is placed at a location in the virtual space that contacts or is adjacent to the graphical object. At least a portion of the graphical object and the corresponding object are displayed that are not occluded by the corresponding object or the graphical object.

### TECHNICAL FIELD

This disclosure relates to the field of displaying objects in computer environments and virtual experiences, and in particular, to methods, systems, and computer readable media for displaying two-dimensional (2D) and three-dimensional (3D) objects at multiple levels of detail in virtual spaces.

### BACKGROUND

Graphical objects can be provided in many displayed virtual spaces including game environments, virtual worlds and experiences, augmented reality environments, interactive online environments, video playback, etc. Graphical objects can be rendered in virtual spaces at different levels of detail (LoD) to reduce the computational processing required to render the them on a display and to reduce the bandwidth required to send them over a network. The level of detail can apply to object geometry of 3D objects (e.g., meshes with varying numbers of polygons or other geometric features) and/or to other object visual features (e.g., texture maps at varying resolution).

In many virtual spaces, a graphical object may have 3D levels of detail or 2D levels of detail. In some cases, a 3D LoD may be provided as a number of polygons in a mesh. For example, an avatar may be displayed as an object having a mesh with a LoD of one million polygons when displayed close to a virtual viewpoint camera, and may be displayed with a mesh with a LoD of 500 polygons when displayed at a far distance from the camera. This type of 3D LoD may be appropriate for objects that are located in a range of very close to mid-range distance to the camera. Such objects are often removed completely from the displayed scene when very distant from the camera, or are replaced with a 2D impostor. In some cases, objects can be represented as 2D objects as such impostors. For example, a palm tree object may be represented as a quadrilateral or 2D rectangle having a picture of the tree on its surface. A 2D LoD object can have different sizes and pixel resolutions at different distances from the player.

For example, a 2D rectangle may have 1024×1024 pixels when viewed from 100 meters away in the virtual space and 32×32 pixels when viewed from 1 kilometer away. This type of 2D LoD representation may be appropriate for objects that are located from mid-range to very distant distances from the camera. The movement of the camera may be constrained to avoid observing a 2D representation of a 3D object up close. 2D LoD of this form is also applied to the texture mapped materials on a 3D object, and in some cases, a 2D impostor can be implemented as a single-polygon model for which texture LoD such as MIP-mapping is applied.

Current techniques for displaying levels of detail of objects have several disadvantages. For example, while there are many techniques for 2D to 2D LoD transitions (such as trilinear MIP-mapping) and for 3D to 3D LoD transitions (such as geometric edge collapse and image space stencil dithering), there are few techniques for producing relatively seamless 3D to 2D, or 2D to 3D, LoD transitions and/or for efficiently displaying LoDs for the entire distance range from the camera.

Another disadvantage is in generation of LoD objects to represent many individual objects. Similar, homogenous meshes may grouped for processing, such as a forest of static tree meshes. However, there are scenarios where objects may drastically differ, and it makes sense to consider the objects as a group. However, most existing LoD systems do not address generation of aggregate LoD meshes, such aggregation does not scale well with a large amount of objects, and/or the system is only set up to process homogeneous content.

The background description provided herein is to present the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations of this application relate to displaying levels of detail of 2D and 3D objects in virtual spaces. In some implementations, a computer-implemented method includes causing a graphical object to be displayed in a virtual space and determining that the graphical object straddles a transition boundary in the virtual space, the transition boundary having a location relative to a virtual camera that provides a displayed view of the virtual space. In response to determining that the graphical object straddles the transition boundary, a corresponding object is obtained that is displayed with a different number of spatial dimensions than the graphical object, and the corresponding object is placed at a location in the virtual space that contacts or is adjacent to the graphical object. At least a portion of the graphical object and at least a portion of the corresponding object are caused to be displayed that are not occluded by the corresponding object or the graphical object.

Various implementations and examples of the method are described. For example, in some implementations, the method further includes determining that a distance between the virtual camera and the graphical object has changed in a particular direction and that the graphical object and the corresponding object are no longer straddling the transition boundary; and in response, halting the display of the graphical object and causing the corresponding object to be displayed to represent the graphical object. In some implementations, the method further includes, in response to determining that the graphical object straddles the transition boundary, matching an update rate of the graphical object with an update rate of the corresponding object. In some implementations, the corresponding object is a corresponding 3D object when the graphical object is a 2D object, and the corresponding object is a corresponding 2D object when the graphical object is a 3D object. In some implementations, the 2D object has a lower update rate than an update rate of the 3D object. In some implementations, the transition boundary is shaped as at least a portion of a sphere. In some implementations, the graphical object is a 3D object and the corresponding object is a 2D object, and obtaining the corresponding object includes generating the 2D object based on a current orientation of the 3D object at the transition boundary relative to the virtual camera.

In some implementations, the graphical object is a 3D object and the corresponding object is a 2D object when a distance between the graphical object and the virtual camera has increased relative to a previous location of the graphical object. In some implementations, the 3D object includes multiple 3D objects, and the method further includes, in response to determining that the graphical object straddles the transition boundary, grouping the multiple 3D objects into a single aggregate 3D object that represents the multiple 3D objects, wherein the corresponding object is the 2D object that is generated based on the aggregate 3D object.

In some implementations, the method further includes determining that the 2D object is positioned more than a threshold distance from the virtual camera, and in response, incorporating the 2D object into a particular skybox portion that is a portion of a skybox object displayed in the virtual space, and removing the 2D object from the virtual space. In some implementations, the method further includes caching the particular skybox portion that includes the 2D object; retrieving one or more other previously-generated skybox portions of the skybox object from one or more caches; and generating an updated skybox object for display in the virtual space, the updated skybox object including the particular skybox portion and the one or more other previously-generated skybox portions. In some implementations, the updated skybox object has an update rate that is lower than the update rate of the 2D object and lower than an update rate of the 3D object.

In some implementations, the graphical object is a 2D object and the corresponding object is a 3D object, and obtaining the corresponding object includes retrieving the 3D object from storage; in some implementations, the 2D object is generated based on the 3D object. In some implementations, the graphical object is a 2D object and the corresponding object is a 3D object when a distance between the graphical object and the virtual camera has decreased relative to a previous location of the graphical object. In some implementations, the graphical object is a second 3D object, and the method further includes causing a first 3D object to be displayed in the virtual space in place of the second 3D object at a distance from the virtual camera below a threshold distance, and causing the second 3D object to be displayed is performed in response to the first 3D object being positioned at greater than the threshold distance from the virtual camera, wherein the second 3D object corresponds to and replaces the first 3D object in the virtual space and the second 3D object has a lower amount of geometric complexity than the first 3D object.

In some implementations, the method further includes determining a movement of the virtual camera from a first location to a second location; determining whether the second location of the virtual camera is within a play region surrounding the virtual camera at the first location; in response to the second location of the virtual camera being within the play region, maintaining the location of the transition boundary based on the first location of the virtual camera; and in response to the second location of the virtual camera being at least partially outside of the play region, updating the location of the transition boundary based on the second location of the virtual camera.

In some implementations, a system comprising at least one processor coupled to a memory having stored thereon software instructions that, when executed by the at least one processor, cause the at least one processor to perform operations. The operations include causing a 3D object to be displayed in a virtual space and determining that the 3D object straddles a transition boundary in the virtual space, wherein the transition boundary has a location relative to a virtual camera that provides a displayed view of the virtual space. The operations include, in response to determining that the 3D object straddles the transition boundary: generating a 2D object corresponding to the 3D object, placing the 2D object in the virtual space at the transition boundary and contacting or adjacent to the 3D object, causing at least a portion of the 3D object that is not occluded by the 2D object to be displayed, and causing a first portion of the 2D object that is not occluded by the 3D object to be displayed, wherein a second portion of the 2D object is occluded by the 3D object and is not displayed. Various implementations and examples of the system are described. For example, in some implementations, the 3D object has a first update rate that is the same as a second update rate of the 2D object.

In some implementations, a computer readable medium comprising with instructions stored thereon that, when executed by a processor, cause the processor to perform operations. The operations include causing a 2D object to be displayed in a virtual space and determining that the 2D object straddles a transition boundary in the virtual space, wherein the transition boundary has a location relative to a virtual camera that provides a displayed view of the virtual space. The operations include, in response to determining that the 2D object straddles the transition boundary: obtaining a 3D object corresponding to the 2D object, placing the 3D object in the virtual space at the transition boundary and contacting or adjacent to the 2D object, causing at least a portion of the 3D object that is not occluded by the 2D object to be displayed, and causing a first portion of the 2D object that is not occluded by the 3D object to be displayed, wherein a second portion of the 2D object is occluded by the 3D object and is not displayed. Various implementations and examples of the system are described. For example, in some implementations, the 3D object has a first update rate that is the same as a second update rate of the 2D object.

Some implementations may include a system that includes a processor and a memory coupled to the processor. The memory may have instructions stored thereon that, when executed by the processor, cause the processor to perform operations that include one or more of the features of the methods and/or a computer readable medium described above. Some implementations may include a computer-implemented method that includes one or more of the operations performed by a processor of a system and/or for a computer readable medium described above. Some implementations include a non-transitory computer-readable medium with instructions stored thereon that, when executed by a processor, cause the processor to perform operations that can be the same or similar to features of the methods and/or systems described above.

### BRIEF DESCRIPTION OF THE DRAWINGS

FIG. 1 is a diagram of an example system architecture, in accordance with some implementations.

FIG. 2 is a flow diagram of an example method to display levels of detail of 2D and 3D objects in a virtual space, in accordance with some implementations.

FIGS. 3A and 3B are flow diagrams of another example method to display levels of detail of 2D and 3D objects in a virtual space, in accordance with some implementations.

FIG. 4 is a diagrammatic illustration of graphical objects displayed at different levels of detail in a virtual space, in accordance with some implementations.

FIG. 5 is a flow diagram of an example method to update a location of a transition boundary in a virtual space that determines a level of detail of displayed objects, according to some implementations.

FIGS. 6A and 6B are diagrammatic illustrations of movement of a virtual camera and transition boundary in a virtual space according to the method of FIG. 5, in accordance with some implementations.

FIG. 7 is a block diagram illustrating an example computing device which may be used to implement one or more features described herein, in accordance with some implementations.

### DETAILED DESCRIPTION

One or more implementations described herein relate to displaying levels of detail of 2D and 3D objects in virtual spaces, e.g., game environments, virtual experiences, augmented reality environments, interactive online environments, video playback, etc. Methods, systems, and computer readable media are described displaying 2D and 3D objects at multiple, dynamically determined levels of detail in virtual spaces. Described computer-implemented methods may include determining that a graphical object straddles a transition boundary in a virtual space, where the transition boundary has a location relative to a virtual camera that provides a displayed view of the virtual space. In response to determining that the graphical object straddles the transition boundary, a corresponding object is obtained that is displayed with a different number of spatial dimensions in the virtual space than the graphical object, and is placed at a location in the virtual space that contacts or is adjacent to the graphical object. Portion(s) of the graphical object and/or the corresponding object are displayed that are not occluded by these objects.

Various other features are also described. The transition boundary can be shaped as a sphere, a plane, a box, or any other surface shape in 3D. The graphical object can be removed and the corresponding object can be displayed as the graphical object if the graphical object and/or the corresponding object move in a particular direction (toward or away from the virtual camera) and are no longer straddling the transition boundary. The graphical object can be a 3D object and the corresponding object can be a 2D object when a distance between the graphical object and the virtual camera has increased, and the graphical object can be a 2D object and the corresponding object can be a 3D object when the distance has decreased. The 2D object can have a lower update rate than an update rate of the 3D object. The 2D object can be generated based on the 3D object and its current orientation relative to the virtual camera. The update rates of the graphical object and corresponding object (e.g., of their first portions) can be matched.

For example, the matched update rate can be lower than the update rate of the 3D object, e.g., an update rate between the update rates of the 3D object and the 2D object.

In various features, if the 2D object is positioned more than a skybox threshold distance from the virtual camera, the 2D object is removed from the virtual space and incorporated into a particular skybox portion of a skybox object displayed in the virtual space. The particular skybox portion can be cached, and one or more other previously-generated skybox portions of the skybox object can be retrieved from caches and included in an updated skybox object generated for display in the virtual space. The updated skybox object can have an update rate that is lower than the update rates of the 2D object and the 3D object.

In various features, the 3D object can include multiple 3D objects that can be grouped into a single aggregate 3D object that represents the multiple 3D objects, such that the corresponding object is the 2D object generated based on the aggregated 3D object. In some implementations, the graphical object can be a second 3D object that corresponds to and is displayed in place of a first 3D object when it is positioned at a greater than a threshold distance from the virtual camera, where the second 3D object includes a fewer number of polygons than the first 3D object. In some implementations, if movement of the virtual camera is within a play region surrounding the virtual camera, the location of the transition boundary is maintained at a previous location, and if the movement is at least partially outside of the play region, the transition boundary is updated based on a current location of the virtual camera.

Features described herein provide improved and efficient display of 2D and 3D objects at different levels of detail in a virtual space. Described features can transition objects between 2D and 3D levels of detail in a virtual space in either direction (e.g., increasing or decreasing distance between camera and objects), to enable representation of 3D objects that can span the entire distance range from very near to very far to a virtual camera. Features enable level of detail systems that are commonly limited to operating either on near to mid-range distances (using lower-fidelity 3D impostors or proxies for 3D objects) or mid to far range distances (using 2D impostors or proxies for 3D objects) to span an entire distance range and use a mixture of 2D and 3D objects. Various features can reduce the perceived visual impact of changing the representation of a 3D object in a computer graphics rendering system from 2D to 3D or 3D to 2D by rendering a transition that conceals the change of representation.

For example, described features display a 3D object and a 2D object concurrently at a particular location in a virtual space, so that the transition from 3D to 2D object, or from 2D to 3D object, is visually masked. For example, the transition from nearby 3D object to a skybox object at the furthest distance from the virtual camera can be made with an intermediary stage in which the graphical object is represented using a 2D object at a particular distance (depth) from the camera (e.g., a “2.5D” object). There can be multiple 3D objects with different levels of detail in the region between camera and a transition boundary. The transition boundary from the 3D object with lowest level of detail to the 2D object can be defined by the surface of a sphere (or other shape) centered at the camera. As a 3D object straddles the boundary, its corresponding 2D object is also generated and rendered, most of which is initially occluded by the 3D object. The occluded portions of the concurrently-displayed objects are not displayed, such that a higher fidelity transition is provided. In addition, the 3D object and the 2D object can be updated (e.g., animated and/or shaded) at the same rate to allow portions of the objects to fully occlude one another and so that an object cannot be seen through the occluding portions of the occluding object. In addition, in some implementations, this allows the 3D object to be updated at a lower rate that is lower than its standard update rate and matches the update rate of the 2D object, which reduces processing and computational resources to update the 3D object. If an object moves completely beyond the transition boundary (further from the camera), the 3D object is removed, and the update rate of the 2D object can also be reduced further.

Described features also include the updating of a skybox object at the furthest distance from the camera in the virtual space. If the 2D object is far enough from the camera, e.g., beyond a skybox threshold distance, it can be incorporated into a skybox portion of the skybox object. The skybox object is divided into multiple portions or sections (e.g., slices or tiles, depending on the chosen skybox projection). For each skybox portion, the 2D objects that cover it are tracked (e.g., stored in memory). When a change occurs (e.g., a 2D object is added or removed from a skybox portion), an updated version of the skybox portion is generated. For each 2D object, its previously generated 2D object is cached separately, so that skybox portions can be regenerated quickly on demand. The skybox portion can be updated at a reduced update rate, as compared to the 3D objects and 2D objects that straddle the transition boundary, and/or compared to the 2D objects between the boundary and the skybox object. Skybox portions that are not visible can be skipped. Updates for visible skybox portions can also be reduced, where only the subset of the changed objects that cover a skybox portion need be generated, and cached 2D objects can be retrieved and used for the other objects when compositing the skybox portions.

Described features also include a reduced update rate for the transition boundary. For example, the camera can be moved within a play region surrounding the camera and the transition boundary can be maintained at a static location until the camera moves out of the play region, thus reducing the processing resources used to update objects that may interact with a moving transition boundary.

Described features also include the use of aggregate objects that represent multiple 3D objects of any type. Most existing LoD systems are not optimized or do not generate aggregate level of detail meshes, often do not scale well with large amounts of objects, and/or are only set up to work with homogeneous content (same or similar multiple objects). However, objects may drastically differ in size, shape, etc. Using described features, such different multiple objects can be considered as a single aggregate object. For example, a city object may be composed of many types of static and dynamic objects, but viewed from a far distance it only has a small screen footprint. Described features of 3D object aggregation allow representation of large collections of non-homogeneous content in a virtual space with high fidelity at different levels of detail and with reduced display processing requirements.

Described features can be used for mobile device graphics, video games, virtual reality, augmented reality, virtual film and TV production, offline rendering, or any implementation in which 3D computer graphics is applied. For offline rendering, the need for performance and visual continuity remains, and offline rendered films make extensive use of both 2D and 3D levels of detail. An example use case is a transition of a computer-generated imagery (CGI) object from being rendered into the 2D background of a volume set for a film into the 3D space of the foreground actors (2D to 3D transition), where it can occlude objects such as characters.

Described features thus provide several technical advantages over previous techniques for providing 2D and 3D objects at different levels of detail in a virtual space. Described features provide technical advantages that enable reduction of use of computational resources (e.g., computer memory, processor use and processing time, networking traffic bandwidth, display processing and memory usage, etc.) in various described implementations. For example, described techniques store, transmit, and process reduced amounts of data compared to previous techniques that may require higher storage, display and network bandwidth, and processing resources to store, transmit, and process, and display objects in the virtual space. For example, described techniques can reduce device processing in updating LoD objects in a virtual space by reducing the update rate of 3D objects at the transition boundary, of 2D objects beyond the transition boundary, and/or of portions of a skybox. Furthermore, processing in updating multiple objects can be reduced by the described implementations of aggregate objects. In addition, updates of the transition boundary with respect to the virtual camera can be reduced by features described herein, thus reducing processing of transitions of objects that may interact with the transition boundary.

Numbers assigned to components herein, such as “first”, “second”, or the like, are only used to distinguish described features and elements, rather than describing a particular order or technical feature.

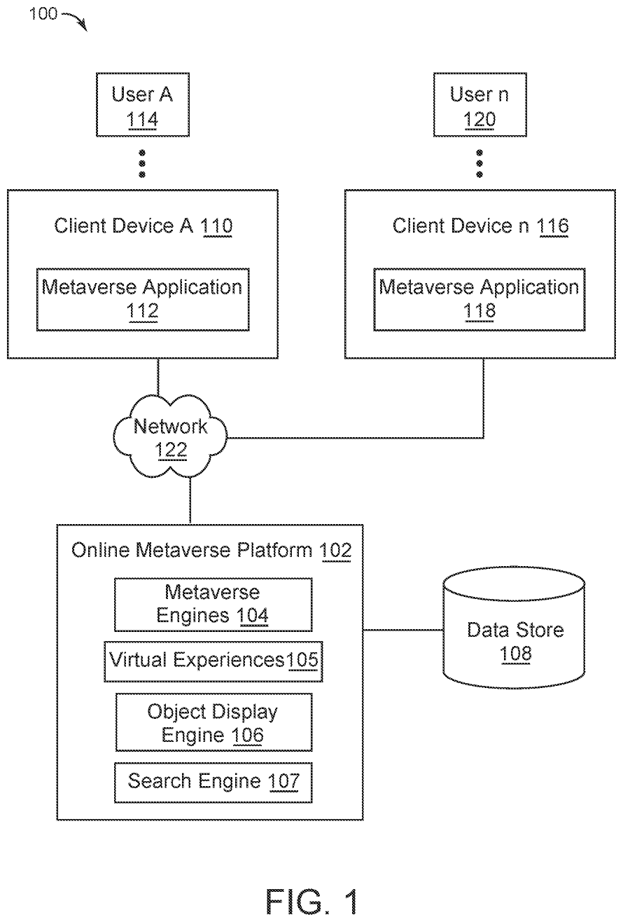

FIG. 1 illustrates an example system architecture 100, in accordance with some implementations of the disclosure. System architecture 100 is provided for illustration. In some implementations, the system architecture 100 may include the same, fewer, more, or different elements configured in the same or different manner as that shown in FIG. 1. System architecture 100 (also referred to as “system” herein) includes an online metaverse platform 102, a first client device 110 (generally referred to as “client devices 110/116” herein), a network 122, and a second client device 116. The online metaverse platform 102 can include, among other things, a metaverse engine 104, one or more virtual experiences 105, an object display engine 106, a search engine 107, and a data store 108. The client device 110 can include a metaverse application 112. The client system 116 can include a metaverse application 118. Users 114 and 120 can use client devices 110 and 116, respectively, to interact with the online metaverse platform 102.

The term “virtual experience” or “game,” as used herein, refers to any virtual experience in a computer environment depicting a 2D or 3D space, including games with specified objectives or end states, as well as other types of games or virtual experiences provided for user(s) in a virtual space for such activities as training, tourism, activity simulation, concerts, meetings, virtual gatherings, etc. that may not have a specific objective or end state. A virtual space can be any graphical environment (2D or 3D) which includes one or more displayed virtual objects, and can be a game environment, a virtual reality environment that is fully generated, an augmented reality environment in which part of the displayed environment is generated by a system and part is based on the actual environment in which a user is located (e.g., displayed as images of the actual environment captured by one or more image capture devices such as physical cameras), etc. The virtual experience may include one or more avatars (e.g., character models). An avatar is a virtual object displayed in the virtual space that may be controlled by a human user, or may be a computer-controlled avatar (e.g., a non-player character controlled by a game or other virtual experience). In various implementations, an avatar may be a humanoid, an animal form, a vehicle form, an object form, or in any other form. In some implementations, the avatar or other 3D virtual object may include a mesh (a set of points arranged in 3D space to obtain an avatar with body parts such as head, torso, limbs, etc.). Further, in some implementations, one or more textures may be attached to a mesh. A texture may define various visual appearances, such as avatar skin parameters, clothing, etc., and can include color, reflectivity, shape, etc. In various implementations, avatar or object animation may be performed automatically by metaverse engine 104 and/or by metaverse applications (112, 118).

A metaverse platform, as described herein, may include any platform that provides one or more virtual experiences having a virtual space or metaverse. A metaverse application, as described herein, may include any application that enables a user to participate in a virtual experience (e.g., game, etc.), and engage in virtual activity or gameplay, including configuring an avatar, moving about in a virtual space, performing actions, engaging with other avatars, interacting with other users via text/audio/video chat, etc.

Online metaverse platform 102 (also referred to as “user-generated content platform” or “user-generated content system”) can offer a variety of ways for users to interact with one another. For example, users of an online metaverse platform may play games or other virtual experiences that are provided by the platform, e.g., games that include player-controlled characters (avatars), non-player characters (avatars), and other virtual objects and mechanisms. Some online metaverse platforms can provide a variety of different environments (e.g., two dimensional or virtual three-dimensional environments) in which users can play in online virtual experiences. In some implementations, users of an online metaverse platform may create games, environments, or other content or resources (e.g., avatars, other objects, graphics, items for game play within a virtual space, etc.) within the metaverse platform. Users of an online metaverse platform may work together towards a common goal in a game or in game creation, share various virtual metaverse items, send electronic messages to one another, and so forth. An online metaverse platform may also allow users of the platform to communicate with each other, e.g., using voice messages (e.g., via audio voice chat), text messaging, video messaging, or a combination of the above.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In one implementation, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online metaverse platform 102 can include a server having one or more computing devices (e.g., a cloud computing system, a rackmount server, a server computer, cluster of physical servers, virtual server, etc.). In some implementations, a server may be included in the online metaverse platform 102, be an independent system, or be part of another system or platform.

In some implementations, the online metaverse platform 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online metaverse platform 102 and to provide a user with access to online metaverse platform 102. The online metaverse platform 102 may also include a website (e.g., one or more webpages) or application back-end software that may be used to provide a user with access to content provided by online metaverse platform 102. For example, users may access online metaverse platform 102 using the metaverse application 112/118 on client devices 110/116, respectively.

In some implementations, online metaverse platform 102 may be a type of social network providing connections between users or a type of user-generated content system that allows users (e.g., end-users or consumers) to communicate with other users via the online metaverse platform 102, where the communication may include voice chat, video chat, or text chat. In some implementations of the disclosure, a “user” may be represented as a single individual person. However, other implementations of the disclosure encompass a “user” (e.g., creating user) being an entity controlled by a set of users or an automated source. For example, a set of individual users federated as a community or group in a user-generated content system may be considered a “user.” In some implementations, a “user” can include one or more programs or virtual entities, as well as persons that interface with the system or network.

In some implementations, online metaverse platform 102 may include a virtual gaming platform. For example, the gaming platform may provide single-player or multiplayer games (and other virtual experiences) to a community of users that may access or interact with games (e.g., user generated games or other games) using client devices 110/116 via network 122. In some implementations, games (also referred to as “video game,” “online game,” or “virtual game” herein) may be two-dimensional (2D) games, three-dimensional (3D) games (e.g., 3D user-generated games), virtual reality (VR) games or environments, or augmented reality (AR) games, for example. In some implementations, games can include environments which may not have game goals, e.g., simulators of particular actions or environments which a player can explore and/or interact with. In some implementations, users may search for games and participate in gameplay with other users in one or more games selected from results of the search. In some implementations, a game selected from results of the search may be played in real-time with other users of the game. In some implementations, gameplay may refer to interaction of one or more players using client devices (e.g., 110 and/or 116) within a virtual experience (e.g., 105) or the presentation of the interaction on a display or other output device of a client device 110 or 116.

In some implementations, other platforms can be used with the techniques described herein instead of or in addition to online metaverse platform 102. For example, a social networking platform, purchasing platform, messaging platform, creation platform, etc. can be used to provide animation modification, generation, and usage features based thereon.

One or more virtual experiences 105 are provided by the online metaverse platform. In some implementations, a virtual experience 105 can include an electronic file that can be executed or loaded using software, firmware or hardware configured to present the virtual experience content (e.g., digital media item) to an entity. In some implementations, a metaverse application 112/118 of a virtual experience may be executed and one or more virtual experience instances can be rendered in connection with a virtual experience 105 and metaverse engine 104. In some implementations, a virtual experience 105 may have a common set of rules and/or common goal, and the environments of a virtual experience share the common set of rules and/or common goal. In some implementations, different virtual experiences 105 may have different rules or goals from one another.

In some implementations, virtual experiences 105 may have one or more virtual spaces where multiple environments may be linked. An example of a virtual space may be a three-dimensional (3D) virtual space. One or more virtual spaces of virtual experience(s) may be collectively referred to a “world” or “gaming world” or “virtual world” or “universe” herein. An example of a world may be a 3D world of a game. For example, a user may build a virtual space that is linked to another virtual space created by another user. An avatar in the virtual space may cross the virtual border of one virtual space to enter an adjacent virtual space.

It may be noted that virtual spaces or 3D worlds use graphics that use a three-dimensional representation of geometric data representative of virtual experience content (or at least present such content to appear as 3D content whether or not 3D representation of geometric data is used). 2D environments or 2D worlds use graphics that use two-dimensional representation of geometric data representative of virtual experience content.

In some implementations, the online metaverse platform 102 can host one or more virtual experiences 105 and can permit users to interact with the virtual experiences 105 (e.g., create, modify, search for, request, and/or join a virtual experience 105, virtual experience instances of virtual experience 105, virtual experience-related content, or other content) using a metaverse application 112/118 of client devices 110/116. Users (e.g., 114 and/or 120) of the online metaverse platform 102 may play, create, interact with, or build virtual experiences 105, search for virtual experiences 105, communicate with other users, create and build objects (e.g., also referred to as “item(s)” or “virtual experience objects” or “virtual experience item(s)” herein) of virtual experiences 105, and/or select or search for objects. For example, when generating user-generated virtual items, users may create avatars, attributes, actions, or animations for the created avatars, decoration for the avatars, one or more virtual spaces for an interactive virtual experience, or build structures used in a virtual experience, among others. In some implementations, users may buy, sell, or trade virtual experience objects, such as in-platform currency (e.g., virtual currency), with other users of the online metaverse platform 102. In some implementations, online metaverse platform 102 may transmit virtual experience content to metaverse applications (e.g., 112). In some implementations, virtual experience content (also referred to as “content” herein) may refer to any data or software instructions (e.g., virtual experience objects, virtual space and features therein, virtual experience, user information, video, images, commands, media item, etc.) associated with online metaverse platform 102 or metaverse applications. In some implementations, virtual experience objects (e.g., also referred to as “item(s),” “objects,” “virtual objects,” or “virtual experience item(s)” herein) may refer to objects that are used, created, shared or otherwise depicted in virtual experiences 105 of the online metaverse platform 102 or metaverse applications 112 or 118 of the client devices 110/116. For example, virtual experience objects may include a part, model, avatar, tools, weapons, clothing, buildings, vehicles, currency, flora, fauna, components of the aforementioned (e.g., windows of a building), and so forth.

In some implementations, a user can create or modify a computer model that is a virtual experience object, such as an avatar used in one or more virtual experiences. For example, the user can create or modify a skeleton (e.g., rig), shape, surface texture and color, and/or other attributes of an avatar. In some examples, an avatar can be similar to a human body model, e.g., can have any of a head, torso/abdomen, arms, legs, hands, feet, joints, etc. and can move similarly to a human body (e.g., walk, run, jump, turn head, move arms, etc.). In some cases, the avatar can have fewer joints than a human body, and in other cases, the avatar can have all joints or more joints than a human body.

In some implementations, an avatar can be animated by a user, e.g., instructed to move within a computer generated environment according to a particular sequence of moves. For example, instructions can be provided to move one or more parts of the avatar (e.g., parts corresponding to limbs or body parts of a humanoid avatar) to one or more different poses, each pose providing particular joint angles for joints of the avatar. The instructions to move the model can be provided from a user in an editor interface, e.g., the user commanding the movement via input in the interface. In some cases, the instructions can be provided from storage and can include a sequence of poses for the avatar.

In some implementations, a virtual camera provides a view of the virtual space that is displayed on a display device for the user (e.g., ion a client device 110 or 116). In various examples, the virtual camera can provide a view that is a first person view from a viewpoint position of an avatar's head or eyes, a third-person view from a viewpoint position behind and/or above the avatar, a view that is not associated with any avatar, or a view from any other position in or external to the virtual space.

It may be noted that the online metaverse platform 102 is provided for purposes of illustration, rather than limitation.

In some implementations, a virtual experience 105 may be associated with a particular user or a particular group of users (e.g., a private virtual experience), or made widely available to users of the online metaverse platform 102 (e.g., a public virtual experience). In some implementations, where online metaverse platform 102 associates one or more virtual experiences 105 with a specific user or group of users, online metaverse platform 102 may associate the specific user(s) with a virtual experience 105 using user account information (e.g., a user account identifier such as username and password).

In some implementations, online metaverse platform 102 or client devices 110/116 may include metaverse engines 104 or metaverse application 112/118. In some implementations, metaverse engines 104 can include a metaverse application similar to metaverse application 112/118. In some implementations, metaverse engines 104 may be used for the development and/or execution of virtual experiences 105. For example, metaverse engines 104 may include a rendering engine (“renderer”) for 2D, 3D, VR, or AR graphics, a physics engine, a collision detection engine (and collision response), sound engine, scripting functionality, artificial intelligence engine, networking functionality, streaming functionality, memory management functionality, threading functionality, scene graph functionality, or video support for cinematics, among other features.

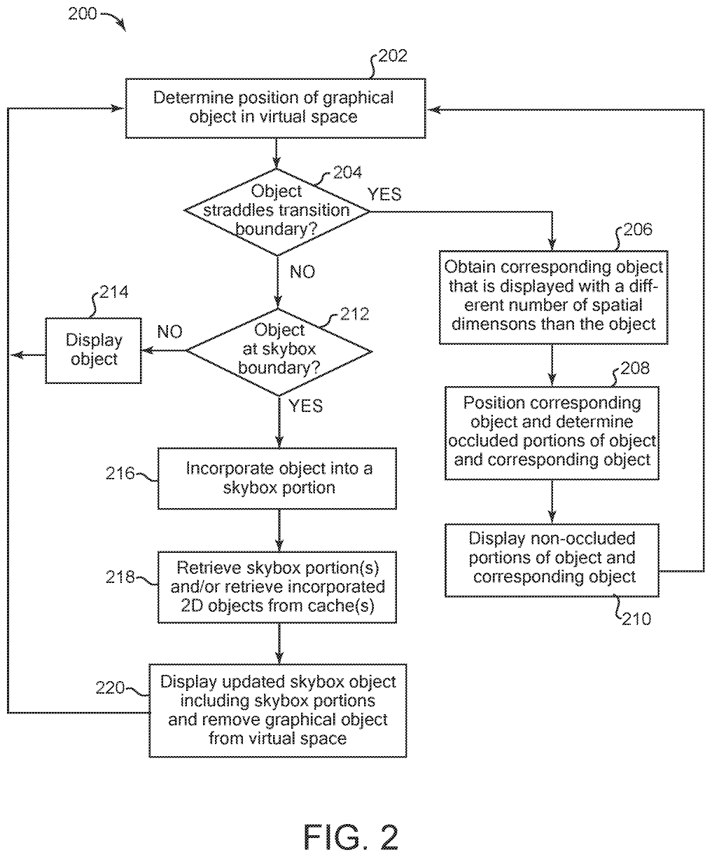

Metaverse platform 102 may also include an object display engine 106 that can interface with metaverse engines 104 and virtual experiences 105. Object display engine 106 can access object and virtual space data, cause and detect movement and interaction of objects, and provide other display functions for objects and other features of a displayed virtual space. Some example methods to display objects at different levels of detail are described below with reference to FIGS. 2-6B. Object data and other data (e.g., virtual space data) can be stored and accessed in database 108 and/or other storage of platform 102. In some implementations, object display engine 106 can be implemented partially or completely on a client device 110 and/or 116.

The components of the metaverse engines 104 may generate commands that help compute and render a virtual experience instance of a virtual experience 105 (e.g., rendering commands, collision commands, physics commands, etc.). In some implementations, metaverse applications 112/118 of client devices 110/116, respectively, may work independently, in collaboration with metaverse engine 104 of online metaverse platform 102, or a combination of both.

In some implementations, both the online metaverse platform 102 and client devices 110/116 execute a metaverse engine/application (104, 112, and 118, respectively). The online metaverse platform 102 using metaverse engine 104 may perform some or all the metaverse engine functions (e.g., generate physics commands, rendering commands, etc.), or offload some or all the metaverse engine functions to metaverse applications 112 and 118 of client devices 110 and 116, respectively. In some implementations, each virtual experience 105 may have a different ratio between the metaverse engine functions that are performed on the online metaverse platform 102 and the metaverse engine functions that are performed on the client devices 110 and 116. For example, a metaverse engine 104 of the online metaverse platform 102 may be used to generate physics commands in cases where there is a collision between at least two game objects, while the additional metaverse engine functionality (e.g., generate rendering commands) may be offloaded to the client device 110. In some implementations, the ratio of metaverse engine functions performed on the online metaverse platform 102 and client device 110 may be changed (e.g., dynamically) based on virtual space or gameplay conditions. For example, if the number of users participating in gameplay of a virtual experience 105 exceeds a threshold number, the online metaverse platform 102 may perform one or more metaverse engine functions that were previously performed by the client devices 110 or 116.

For example, players may be participating in a virtual experience instance of virtual experience 105 on client devices 110 and 116, and may send control instructions (e.g., user inputs, such as directional inputs of right, left, up, down, avatar position and velocity information, text, voice input, etc.) to the online metaverse platform 102. Subsequent to receiving control instructions from the client devices 110 and 116, the online metaverse platform 102 may send instructions (e.g., position and velocity information of the avatars participating in the group gameplay or commands, such as rendering commands, collision commands, etc.) to the client devices 110 and 116 based on control instructions (e.g., including avatar and object animation data). For instance, the online metaverse platform 102 may perform one or more logical operations (e.g., using metaverse engine 104) on the control instructions to generate gameplay instruction for the client devices 110 and 116. In other instances, online metaverse platform 102 may pass one or more or the control instructions from one client device 110 to other client devices (e.g., 116) participating in the virtual experience instance. The client devices 110 and 116 may use the gameplay instructions and render the gameplay for presentation on the displays of client devices 110 and 116.

In some implementations, the control instructions may refer to instructions that are indicative of actions of a user-controlled avatar in a virtual space. For example, control instructions may include user input to control the action, such as right, left, up, down, user selection, gyroscope position and orientation data, force sensor data, text, voice input, etc. The control instructions may include avatar position and velocity information. In some implementations, the control instructions are sent directly to the online metaverse platform 102. In other implementations, the control instructions may be sent from a client device 110 to another client device (e.g., 116), where the other client device generates control instructions using the local metaverse application 118. The control instructions may include instructions to play a voice communication message or other sounds from another user on an audio device (e.g., speakers, headphones, etc.).

In some implementations, control instructions may refer to instructions that allow a client device 110 (or 116) to render play experience of a virtual experience in a virtual experience instance. The control instructions may include one or more of user input, avatar position and velocity information, or commands (e.g., physics commands, rendering commands, collision commands, etc.). In some implementations, the control instructions can cause an animation associated with a graphical object, such as an avatar or other object, to be displayed in the virtual experience.

In some implementations, virtual objects are constructed from components, one or more of which may be selected by the user, that automatically join together to aid the user in editing. One or more avatars (also referred to as a “character,” or “character model” herein) may be associated with a user where the user may control the avatar when playing a virtual experience 105 to facilitate the player's interaction with the virtual experience 105. In some implementations, an avatar may include components such as body parts (e.g., hair, arms, legs, etc.) and accessories (e.g., t-shirt, glasses, decorative images, tools, etc.). In some implementations, body parts of avatars that are customizable by a player include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools. In some implementations, a player may control the scale (e.g., height, width, or depth) of an avatar or the scale of components of an avatar. In some implementations, the player may control the proportions of an avatar (e.g., blocky, anatomical, etc.).

In some implementations, a component, such as a body part, may be a primitive geometrical shape such as a block, a cylinder, a sphere, etc., or some other primitive shape such as a wedge, a torus, a tube, a channel, etc. In some implementations, a creation and editing module and interface of metaverse application 112/118 (or virtual experience engines 104) may publish a user's avatar for view or use by other users of the online metaverse platform 102. In some implementations, creating, modifying, or customizing avatars, other virtual experience objects, virtual experiences 105, or virtual spaces may be performed by a user using a user interface (e.g., developer interface) and with or without scripting (or with or without an application programming interface (API)). For example, a developer interface can be displayed by a client device 110 and the user at the client device can select user interface commands to create and/or modify objects (including avatars), environments, and scripts for a virtual experience. It may be noted that for purposes of illustration, rather than limitation, avatars are described as having a humanoid form. It may further be noted that avatars may have any form such as a vehicle, animal, inanimate object, or other form.

Avatar settings can also include one or more animations associated with an avatar. An animation, when played, causes the avatar to move within the environment and/or move particular body parts or other physical features of the avatar. An animation includes a sequence of multiple poses which the avatar assumes in a virtual space to cause the avatar to move or be otherwise changed in physical (displayed) appearance. Some animations can be designated to play for the avatar in response to a user command during the virtual experience, such as an action to move the avatar in the virtual space, act on a different object in the virtual space, a specific command to play the particular animation, etc.

In some implementations, online metaverse platform 102 may include a search engine 107. In some implementations, the search engine 107 may be a system, application, or module that permits the online metaverse platform 102 to provide search functionality to users, where the search functionality permits the users to search virtual experiences 105 that are available, the most popular virtual experiences, virtual experience instances that are looking for players, virtual experience assets available on the metaverse platform 102, etc.

In some implementations, the client device(s) 110 or 116 may each include computing devices such as personal computers (PCs), mobile devices (e.g., laptops, mobile phones, smart phones, tablet computers, or netbook computers), network-connected televisions, gaming consoles, etc. In some implementations, a client device 110 or 116 may also be referred to as a “user device.” In some implementations, one or more client devices 110 or 116 may connect to the online metaverse platform 102 at any given moment. It may be noted that the number of client devices 110 or 116 is provided as illustration, rather than limitation. In some implementations, any number of client devices 110 or 116 may be used.

In some implementations, each client device 110 or 116 may include an instance of the metaverse application 112 or 118, respectively. In one implementation, the metaverse application 112 or 118 may permit users to use and interact with online metaverse platform 102, such as search for a virtual experience or other content, control a virtual avatar in a virtual experience hosted by online metaverse platform 102, or view or create or upload content, such as virtual experiences 105, images, avatars, and other objects, model animations, videos, web pages, documents, and so forth. In one example, the metaverse application may be a web application (e.g., an application that operates in conjunction with a web browser) that can access, retrieve, present, or navigate content (e.g., avatar in a virtual space, etc.) served by a web server. In another example, the metaverse application may be a native application (e.g., a mobile application, app, or a gaming program) that is installed and executes local to client device 110 or 116 and allows users to interact with online metaverse platform 102. The metaverse application may render, display, or present the content (e.g., a web page, a media viewer) to a user. In an implementation, the metaverse application may also include an embedded media player (e.g., a Flash® player) that is embedded in a web page.

According to aspects of the disclosure, the metaverse application 112/118 may be an online metaverse platform application for users to build, create, edit, upload content to the online metaverse platform 102 as well as interact with online metaverse platform 102 (e.g., play virtual experiences 105 hosted by online metaverse platform 102). As such, the metaverse application 112/118 may be provided to the client device 110 or 116 by the online metaverse platform 102. In another example, the metaverse application 112/118 may be an application that is downloaded from a server.

In some implementations, a user may login to online metaverse platform 102 via the metaverse application. The user may access a user account by providing user account information (e.g., username and password) where the user account is associated with one or more avatars available to participate in one or more virtual experiences 105 of online metaverse platform 102.

In general, functions described in one implementation as being performed by the online metaverse platform 102 can also be performed by the client device(s) 110 or 116, or a server, in other implementations if appropriate. In addition, the functionality attributed to a particular component can be performed by different or multiple components operating together. The online metaverse platform 102 can also be accessed as a service provided to other systems or devices through appropriate application programming interfaces (APIs), and thus is not limited to use in websites.

FIG. 2 is a block diagram illustrating an example method 200 to display levels of detail of 2D and 3D objects in a virtual space, in accordance with some implementations. In some implementations, method 200 can be implemented, for example, on a server system, e.g., online metaverse platform 102 as shown in FIG. 1. In some implementations, method 200 can be performed at least in part by metaverse engine(s) 104 of online metaverse platform 102. In some implementations, some or all of the method 200 can be implemented on a system such as one or more client devices 110 and 116 as shown in FIG. 1, and/or on both a server system and one or more client systems. For example, in some implementations, method 200 can be performed at least in part by metaverse application(s) 112 of client devices 110, 116. In described examples, the implementing system includes one or more processors or processing circuitry, and one or more storage devices such as a database, data structure, or other accessible storage. In some implementations, different components of one or more servers and/or clients can perform different blocks or other parts of the method 200. Method 200 may begin at block 202.

In block 202, a location of a graphical object is determined in a virtual space. In some implementations, other characteristics of the graphical object are also determined, e.g., a direction and/or velocity of the graphical object, and/or a distance between the virtual camera and the graphical object (e.g., depth of the graphical object). For example, the graphical object is displayed in a virtual space by one or more display devices. The virtual space can be any environments described above with reference to FIG. 1. In some examples, the object can be a 3D object that includes a 3D geometrical description of the object, such as a mesh of polygons, rig connections and nodes, or other type of description, as well as including textures that cover surfaces of the mesh polygons. For example, the object can be an avatar or other character in the virtual space, an environmental object (e.g., furniture object, tree, vehicle, ball, etc.), a terrain object (e.g., mountain, bridge, building, sun, moon, etc.), etc. The object may be animated to include one or more motions of the object in the virtual space performed over time.

In further examples, the object can be a 2D object, such as a quadrilateral or rectangle, circle, or other 2D geometric shape, which can include pixels that portray one or more 2D images. The 2D images can correspond to the 3D object if the 2D object represents and/or is generated from the 3D object as described below. In various implementations, the 2D object can be a flat surface. In some implementations, the 2D object can have an alpha-masked image texture mapped onto it to appear as a 3D object in the distance, e.g., to imply visual detail that is not modeled by the geometry or other texture mapped properties that support 3D shading such as surface normals. This image may also change over time by using video or a sequence of images that can provide animation. The 2D object can have a fixed orientation in 3D, can automatically rotate to face towards the camera, or can automatically rotate to be parallel to a particular image plane (e.g., a skybox object). In various implementations, the 2D object (displayed at the transition boundary or between transition boundary and skybox boundary as described below) can be displayed using render to texture techniques for a dynamic billboard type of 2D object, or can be displayed using a stencil buffer similar to screen-door transparency, as a layered depth texture, using displacement mapped geometry techniques, etc.

In some implementations, the graphical object can be an avatar. For example, the avatar can appear as a 3D model in a 3D virtual space, or appear as a 2D model, bitmap, or sprite in a 2D virtual space, representing a person, animal, vehicle, object or article, etc., that includes visual textures including pixels providing a visual appearance. In some examples, the avatar represents and is controlled by a user, e.g., a user or player in a game or other virtual experience, so that the user can, e.g., cause the avatar to move by inputting directional commands to the virtual experience, to perform actions by inputting other commands to the virtual experience, etc. In further examples, the avatar may not be controlled by any human user, e.g., may be a non-player character (NPC) or other object in a game or other virtual experience.

The location of the object determined in block 202 can be based on or relative to a location of a virtual camera in the virtual space. For example, the virtual camera provides a display view (or viewpoint or viewport) of the virtual space. In some implementations, the virtual camera is located at a location of a user-controlled avatar and provides a field of view of the virtual space from a location on the avatar (e.g., eyes or head), where a user controlling the avatar can move (e.g., translate and/or rotate) the camera by moving the avatar. In other examples, the virtual camera can be positioned above and/or behind the avatar, or is not associated with an avatar, e.g., can be stationary at a particular location in the virtual space, can be provided in the virtual space as an invisible object, etc.

The location of the graphical object can be determined with respect to one or more boundaries in the virtual space. In some implementations, the boundaries can be defined based on any of various characteristics of the virtual camera, such as a particular distance from the virtual camera (or an object associated with the virtual camera) within the virtual space. For example, in some implementations, a transition boundary and a skybox boundary can be defined at particular distances from the virtual camera. Block 202 may be followed by block 204.

In block 204, it is determined whether the graphical object is positioned at (e.g., straddles) a transition boundary. The transition boundary is a particular boundary at which the graphical object can be transitioned to a corresponding object that represents the graphical object and is displayed with a different number of dimensions than the graphical object. In some cases, use of the corresponding object may reduce processing and display requirements in the display of the object. For example, if the graphical object is a 3D object, it can be transitioned to a corresponding 2D object at the transition boundary (e.g., the distance between object and camera has increased when the object has moved away from the virtual camera, and/or the virtual camera has moved away from the object). Or, if the object is a 2D object, it can be transitioned to a 3D object at the transition boundary (e.g., the distance between object and camera has decreased when the object has moved toward the virtual camera and/or the virtual camera has moved toward the object). In some implementations, the transition boundary can be a particular distance from the virtual camera and within the field of view of the virtual camera. For example, the transition boundary can be a spherical boundary (or a portion of a sphere) having a center at the virtual camera and a radius equal to the particular distance from the virtual camera. In some implementations, the transition boundary can be curved according to other shapes, e.g., an ellipse or an irregular curved shape. In various implementations, the transition boundary can be a plane, box, rectilinear, can include planar portions, or can be any other surface shape. In some implementations, the transition boundary can have a width, e.g., a small width of a single pixel or a single unit of distance, or a larger width that defines a continuous span or range of distances from the virtual camera at which an object is considered to be straddling or contacting the transition boundary.

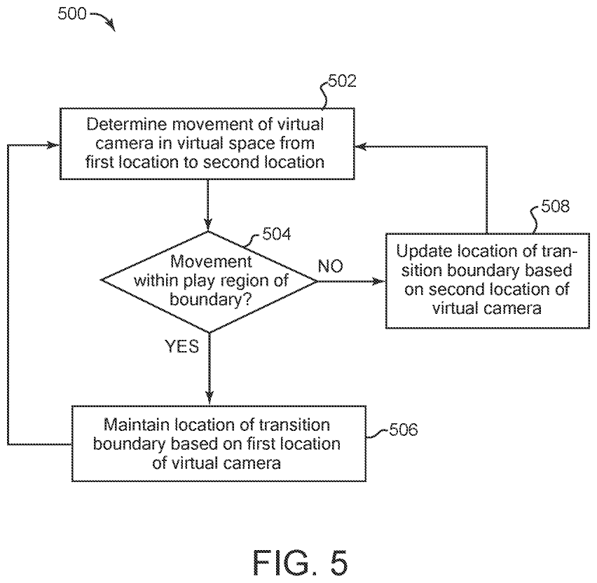

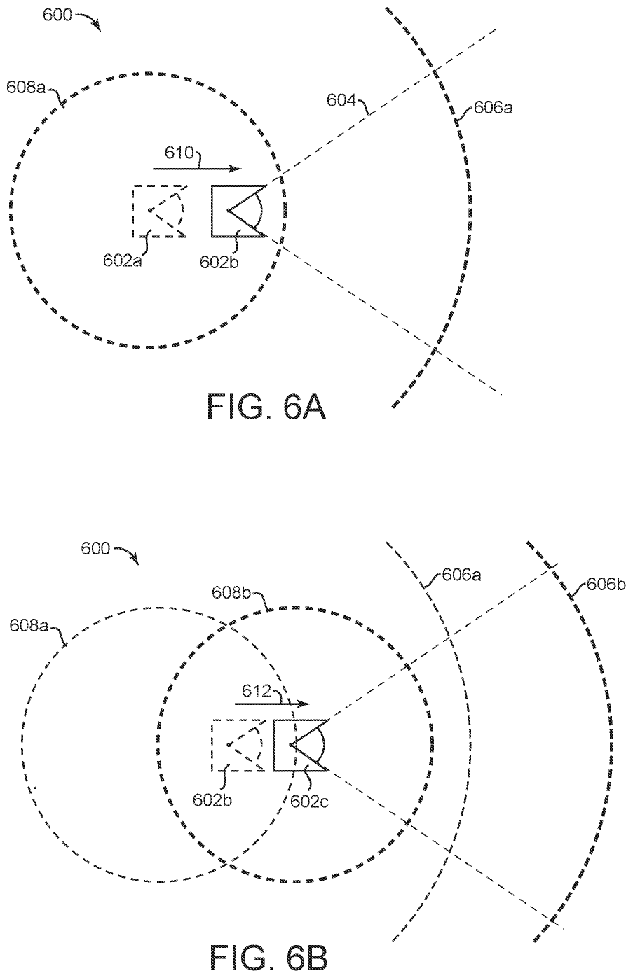

In some implementations, the location of the transition boundary in the virtual space relative to the virtual camera may be updated periodically or upon specific conditions being met. In some implementations, the location of the transition boundary can be updated less frequently than the location of the virtual camera. For example, the location of the transition boundary can be updated every particular number of frames. In some implementations, the location of the transition boundary can be updated if the virtual camera (e.g., the center of the camera) moves more than a threshold distance from its prior location, e.g., outside a play region that surrounds and is centered on the camera at the prior location. This allows the virtual camera to move within a particular range around an initial camera location without the location of the transition boundary being updated. Some examples are described below with reference to FIGS. 5 and 6A-6B.

If the graphical object is positioned at the transition boundary, the method continues to block 206, in which a corresponding graphical object is obtained that is displayed with a different number of spatial dimensions than the graphical object. For example, the corresponding object is represented in the virtual space as an object having a different number of spatial dimensions than the graphical object represented in the virtual space. For example, if the object is a 3D object that is displayed as a spatial 3D object in the virtual space, a corresponding 2D object is obtained that is displayed as a spatial 2D object in the virtual space; and if the object is a 2D object that is displayed as a spatial 2D object in the virtual space, a corresponding 3D object is obtained that is displayed as a spatial 3D object in the virtual space.

In some implementations, the corresponding object is generated based on the object, e.g., without retrieving or using a corresponding object that was previously generated or stored as a proxy for the object. For example, if the object is a 3D object, the corresponding object can be or include a 2D object (e.g., bitmap) that is generated based on a current state of the 3D object, e.g., based on a view projection of the 3D object along the line of sight of the virtual camera using particular generation techniques. In some implementations, the 2D object can be generated based on the current orientation of the 3D object relative to the virtual camera at the transition boundary. In some implementations, the 2D object can be a “2.5D” object that also includes a depth or distance attribute that indicates the distance of the 2D object from the virtual camera. In some implementations, the transition boundary can be selected to be sufficiently distant from the virtual camera so that the lack of parallax and shading on the 2D object are not noticeable when the 2D object is viewed by a viewer.

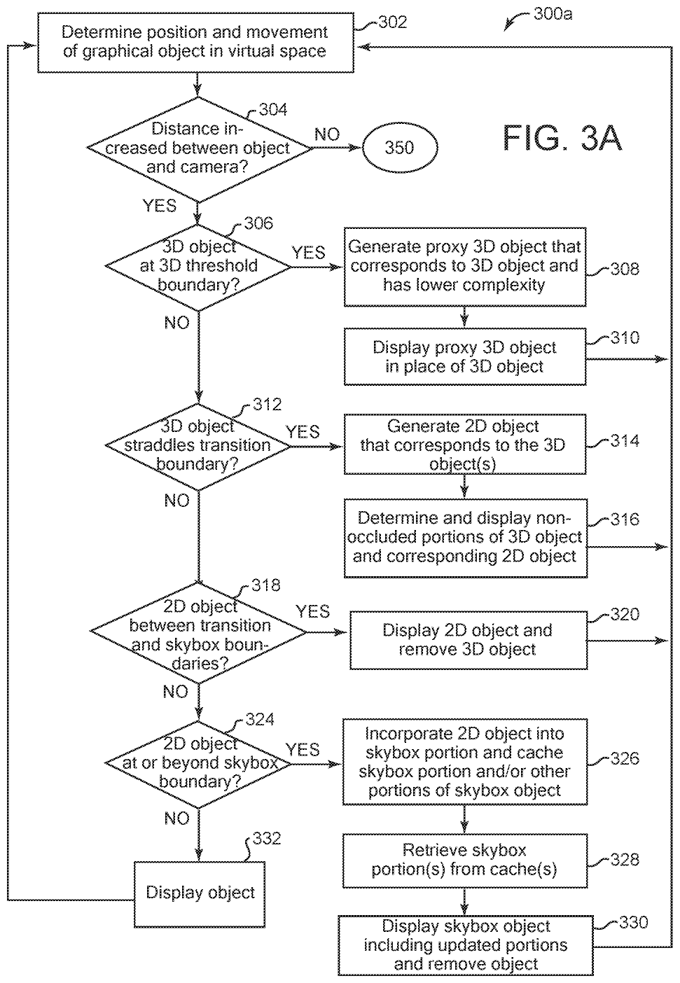

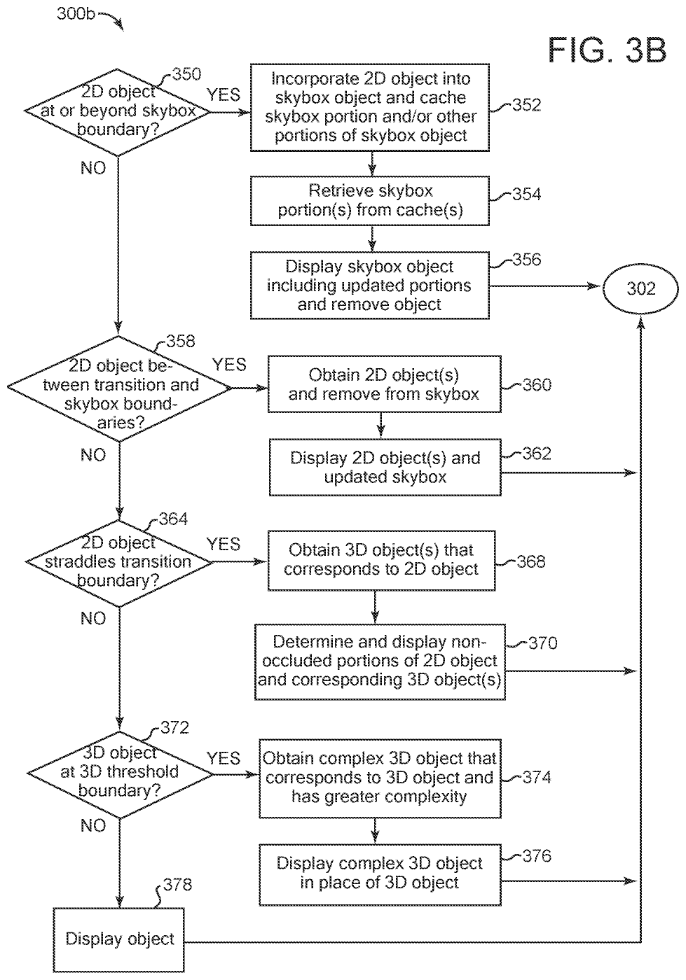

In some cases, if the object is a 2D object, the corresponding object can be an associated 3D object that is retrieved from storage in local and/or remote storage. For example, the 2D object may have been previously generated from the corresponding 3D object at an earlier iteration of method 200, and the 3D object is stored in association with the 2D object. In some implementations, an aggregate object can be determined from multiple sub-objects at or near the transition boundary, as described below with reference to FIGS. 3A-3B. Block 206 may be followed by block 208.

In block 208, the corresponding object is positioned in the virtual space and occluded portions of the object and the corresponding object are determined. For example, the corresponding object can be positioned in contact with or adjacent to the graphical object. In some examples, the corresponding object can be positioned at or within the transition boundary and/or contacting the transition boundary. In some examples, the corresponding object can be positioned such that the center of the corresponding object is aligned with the center of the existing object (e.g., along a line intersecting the center of the existing object and the virtual camera). In other examples, the corresponding object can be positioned such that its center or edge contacts an edge or side of the existing object (the graphical object). In some implementations, the corresponding object is positioned along a line of sight or view axis that extends from the virtual camera and intersects the existing object, so that the corresponding object is aligned with the existing object in the field of view of the virtual camera, e.g., at least partially in front of or in back of the existing object as viewed by the virtual camera.

Occluded portions of the object and/or the corresponding object are determined based on their locations in the virtual space relative to the virtual camera. For example, the occluded portions are determined based on the field of view of the camera and/or the line of sight from the camera to the objects. For example, in the view of the camera, the corresponding object may be occluding one or more portions of the existing object, and/or the existing object may be occluding one or more portions of the corresponding object. The occluded portions of the 2D object can be determined by, for example, determining which portions of the 3D object occlude the 2D object from the camera. For example, in some implementations, lines of sight can be traced from the camera to each portion of the 2D object to determine if a portion of the 3D object is positioned in front of the 2D object along that line. The occluded portions of the 3D object can be determined by, for example, determining which portions of the 3D object extend beyond the transition boundary, which may be considered as the occluded portions (and/or these 3D object portions may be clipped or removed from the virtual space). Block 208 may be followed by block 210.

In block 210, the non-occluded portions of the graphical object and the corresponding object are displayed, e.g., caused to be rendered by a display device. The occluded portions of these objects are not displayed. For example, a 2D corresponding object that has been added behind a 3D object will be mostly occluded by the 3D object and therefore, not displayed.

In some implementations, the transition boundary acts as a clipping surface for the 3D object, such that any portions of the 3D object that extend past the transition boundary (or past a particular point within a wider transition boundary) in a direction away from the virtual camera are clipped and not displayed. In some implementations, the clipping can be per-pixel clipping of the 3D object (e.g., instead of standard per-vertex clipping). In some implementations, geometric clipping can be employed, e.g., equivalent to that performed at a clipping plane such as on the view frustum, as long as there is suitable precision to avoid single-pixel gaps and overlaps in the boundary of the clipped object. Alternatively, per pixel clipping can ensure a seamless boundary with a simpler implementation but potentially higher runtime cost.

The graphical object and the corresponding object each have a respective update rate. An update rate of an object, as referred to herein, is the rate of the object being modified visually in the virtual environment, e.g., with different pixel colors, with addition or removal of pixels to or from the object, etc. For example, the update rate can include a frame rate at which the object changes to each new frame of an animation, where the graphical object is animated using multiple frames, each frame showing a difference in position, shape, color, size, etc. of the object (or a portion of the object) such that the object appears to move, change color or texture, or otherwise change as the multiple frames are displayed sequentially. In another example, the update rate can include a shading rate, which is a rate at which the object is updated with shades or colors; such shades or colors may change depending on changes in object position with respect to one or more light sources in the virtual space, changes in light sources in the virtual space, etc. The update rate can also refer to the rate of updating the object with other changes in shades, colors, or pixels/polygons of the object.

In some implementations, the graphical object and the corresponding object are updated at the same update rate so that an object can effectively occlude the other object. If the objects are not updated at the same update rate, portions of one object occluded by the other object may be visible through or in addition to the other object. For example, an animated arm of a 3D character that has a 2D corresponding object may extend past the transition barrier. If the 3D version of the arm is updated at a different update rate than the 2D version of the arm, their animations may become unsynchronized and two arms may be displayed. Such mis-synchronization may be more apparent when the 3D object includes a transparent portion through which 2D corresponding portions can be viewed. In some implementations, the update rate of the 3D object can be reduced while straddling the transition boundary, as described below with reference to method 300 of FIGS. 3A-3B.

In subsequent iterations of method 200, the graphical object and corresponding object can be displayed concurrently in block 210 while the graphical object and/or corresponding object straddle the transition boundary. When one or more of these objects are no longer straddling or in contact with the transition boundary, the graphical object or the corresponding object can be removed from the virtual space. The object that is removed is based on whether the distance between virtual camera and the object continues to change in a same direction (e.g. increase or decrease) as in the previous iteration, in which case the graphical object may be removed, which leaves the corresponding object to be displayed to represent the graphical object in the virtual space. If the distance changes in the opposite direction from the previous iteration (e.g., the graphical object moves towards the camera after moving away), the corresponding object may be removed and the graphical object displayed.

Block 210 may be followed by block 202, in which the method continues to determine a location of the graphical object in the virtual space. For example, the graphical object and/or virtual camera may have moved based on user input to the virtual space, characteristics of the object (e.g., velocity), events or conditions occurring in the virtual space, etc.

If the existing object is not positioned at the transition boundary as determined in block 204, the method continues to block 212, in which it is determined whether the object is positioned at a skybox boundary. The skybox boundary is a particular boundary at which, in a direction away from the camera, a 2D object can be removed from the virtual space and is added to (e.g., incorporated into) a skybox object that is displayed in the virtual space. This can reduce processing resources utilized in the display of the object. If the object is located at the skybox boundary after having moved in a direction toward the camera, the object that is incorporated in the skybox object can be removed from the skybox object and is displayed as an individual 2D object at the skybox boundary.

The skybox object can be a large 2D object that is a flat bitmap that is mapped to fit the virtual space, e.g., as a sky, horizon, or other background, and is displayed at the furthest distance from the virtual camera that objects are displayed within the virtual space. The skybox object can be mapped to the virtual space from a cube or other shape (e.g., sphere, dome, etc.)

and surrounds the virtual space. The skybox object can be static (has no changing visual features or effects), or can be dynamic/procedural (e.g., may include changing visual features or effects such as moving images or video). The skybox boundary is at a greater distance from the virtual camera than the transition boundary and is within the field of view of the virtual camera. In some implementations, the skybox boundary can be spherical (or partially spherical), planar, etc., and can be similar to or different from the transition boundary described for block 204. For example, the skybox boundary can be a spherical (or part of a sphere) boundary having a center at the virtual camera and a radius equal to a particular distance from the virtual camera.

If the graphical object is not positioned at the skybox boundary, the method continues to block 214, in which the graphical object is caused to be displayed. For example, the object is rendered in the virtual space on one or more display devices. In some implementations, if two objects have been displayed in the previous iteration of method 200 based on a performance of block 210 at the transition boundary, one of the objects may be removed from the display if appropriate to the current locations of these objects relative to the transition boundary. For example, if the objects are displayed on the near side of the transition boundary to the virtual camera, the 2D object can be removed, and if the objects are displayed on the far side of the transition boundary to the virtual camera, the 3D object can be removed. In some implementations, multiple versions of the 3D object can be displayed on a near side of the transition boundary at different distances to the camera, as described below with reference to FIGS. 3A and 3B.

Block 214 may be followed by block 202, in which the method continues to determine a location of the graphical object in the virtual space. For example, the graphical object and/or virtual camera may have moved based on user input to the virtual space and/or based on events or conditions occurring in the virtual space.

If the graphical object is positioned at the skybox boundary as determined in block 212, the method continues to block 216, in which the object is incorporated into a skybox portion of the skybox object and the object is removed from the virtual space. In some implementations, the object is an object that has moved toward the skybox object and arrived at the skybox boundary. In some implementations, the object is a 2D object that was generated at the transition boundary in blocks 206-210 and is being displayed at a far distance from the virtual camera (e.g., it was a 3D object that was converted into a 2D object at the transition boundary of block 204). If the object is at or beyond the skybox boundary and is already incorporated in the skybox object (e.g., from a previous iteration of method 200), then blocks 216-220 can be skipped and the skybox object can continue to be displayed (block 212 can be followed by block 202).

The skybox portion can, in some implementations, be one of multiple portions of the entire skybox object. For example, the skybox object can be divided into portions that cover its entire area. For example, the skybox object can be subdivided into tiles or slices (depending on the chosen projection). The portions, in some implementations, may be regular and repeating shapes, such as square or rectangular regions or regions of other shapes. Alternatively, the skybox portions can be irregular and/or have different shapes that cover the area of the skybox object. In some implementations, the skybox portion can be the entire skybox object, e.g., there is only one portion that covers the entire area of the skybox object. The 2D object is incorporated into an associated skybox portion, e.g., a skybox portion that encompasses an area at the skybox boundary that is intersected by the 2D object. In some implementations, if the 2D object intersects two or more skybox portions, it can be incorporated into the portion having the most area intersected by the 2D object.

The 2D object can be incorporated into the associated skybox portion by stitching or pasting the 2D object into the skybox portion at a location that corresponds to the object. For example, the location of the skybox can be the area of intersection of the object and skybox portion. For example, the 2D object bitmap texture can be stitched directly into the skybox bitmap, e.g., its pixel values placed over any corresponding pixel values in the skybox portion.

In some implementations or cases, a 3D object can be moved to and positioned at the skybox boundary. In some implementations, the 3D object can be converted into a 2D object (e.g., similarly as in block 206) and the 2D object can then be incorporated into the skybox object similarly as described above. Block 216 may be followed by block 218.

In block 218, portion(s) of the skybox object can be retrieved and/or one or more incorporated 2D objects can be retrieved from skybox portion cache(s) (or other storage). These skybox portions, along with the updated skybox portion of block 216, constitute the entire displayed area of the skybox object in the virtual space. These skybox portions include other skybox portions that have been cached and cover the displayed area of the skybox object other than the associated skybox portion described above. In some implementations, the other skybox portions are cached, e.g., when the skybox object was created or when the other skybox portions were updated with other 2D objects being added or removed from those skybox portions. The latest versions of the other skybox portions that form the skybox object can be retrieved, which may or may not include one or more incorporated 2D objects. Skybox portions of the skybox object that are not in the field of view of the virtual camera can be skipped in the retrieval.

In some cases or implementations, one or more incorporated 2D objects can also or alternatively be retrieved from the skybox caches. These objects can be other 2D objects that have been incorporated into the same associated skybox portion that the current 2D object was incorporated into in block 216. If these other 2D objects have not changed (e.g., have not moved out of the skybox object and closer to the camera), then the cached versions of these objects can be retrieved and do not need to be regenerated. In some implementations, aggregated 2D skybox objects and/or aggregated skybox portions can be retrieved in block 218, similarly as described below for block 326 of FIG. 3. Block 218 may be followed by block 220.

In block 220, an updated skybox object is displayed that includes the skybox portions, and the graphical object is removed from the virtual space. For example, the updated skybox object can be composited from the updated skybox portion that includes the graphical object(s) incorporated in block 216 and can include other 2D objects retrieved from the cache in block 218. The updated skybox object also includes the other skybox portions retrieved in block 218. Skybox portions of the skybox object that are not in the field of view of the virtual camera can be skipped and not retrieved or displayed. The updated skybox object can be displayed by a display device that is displaying the virtual space, e.g., in a virtual experience. Furthermore, the graphical object (e.g., 2D object) may be removed from the virtual space. For example, the object can be deleted from the virtual space or can be updated to be invisible to the virtual camera such that it will not be displayed (e.g., in block 220), e.g., by changing one or more attributes of the object.

In some implementations, as indicated in blocks 216 to 220, the skybox object is dynamic, and one or more portions of the skybox are updated over time based on objects moving to and from the skybox boundary. In some implementations, only the portions of the skybox that have changed need to be generated for display, and the other portions of the skybox can be retrieved from the cache or other storage for display. In some implementations, all of the 2D objects incorporated in the skybox object can be tracked, where the identifications and locations of the 2D objects within the skybox portions, and the identifications of the associated incorporating skybox portions, are stored to allow determination of which 2D objects are incorporated in which skybox portions.

Block 220 may be followed by block 202, in which the method continues to determine a location of the graphical object in the virtual space. For example, the graphical object and/or virtual camera may have moved based on user input to the virtual space, characteristics of the object (e.g., velocity), events or conditions occurring in the virtual space, etc.

In various implementations, various blocks of method 200 may be combined, split into multiple blocks, performed in parallel, or performed asynchronously. In some implementations, one or more blocks of these methods may not be performed or may be performed in a different order than shown in these figures. Method 200, or portions thereof, may be repeated any number of times using additional inputs.

FIGS. 3A and 3B are flow diagrams illustrating another example method 300 to display levels of detail of 2D and 3D objects in a virtual space, in accordance with some implementations. Method 300 is collectively shown by method 300a (in FIG. 3A) and method 300b (in FIG. 3B). Method 300a includes blocks related to operations performed in response to an increase in the distance between the graphical object and the virtual camera, and method 300b includes blocks related to operations performed in response to a decrease in the distance between graphical object and virtual camera. In some implementations, features of method 300 that correspond to features of method 200 may be similarly implemented as described above for method 200.

In some implementations, method 300 can be implemented, for example, on a server system, e.g., online metaverse platform 102 as shown in FIG. 1. In some implementations, method 300 can be performed at least in part by metaverse engine(s) 104 of online metaverse platform 102. In some implementations, some or all of the method 300 can be implemented on a system such as one or more client devices 110 and 116 as shown in FIG. 1, and/or on both a server system and one or more client systems. For example, in some implementations, method 300 can be performed at least in part by metaverse application(s) 112 of client devices 110, 116. In described examples, the implementing system includes one or more processors or processing circuitry, and one or more storage devices such as a database, data structure, or other accessible storage. In some implementations, different components of one or more servers and/or clients can perform different blocks or other parts of the method 300.

Referring to FIG. 3A, method 300 may begin at block 302. In block 302, a location and movement (e.g., direction) of a graphical object is determined in a virtual space. In some implementations, other characteristics of the graphical object are also determined, e.g., a velocity within the virtual space, and/or a distance between the virtual camera and the graphical object (e.g., depth of the graphical object). For example, the object is displayed by one or more display devices in the virtual space. The object can be a 3D object or 2D object similarly as described for method 200 of FIG. 2. The virtual space can be part of any of the virtual experiences or environments described herein, e.g., as with reference to FIG. 1. The location and movement of the object determined in block 302 can be similar as described above for method 200 of FIG. 2.

The location of the object can be determined with respect to one or more boundaries in the virtual space. In some implementations, the boundaries can be defined based on any of various characteristics of the virtual camera, such as a particular distance from the virtual camera (or an avatar associated with the virtual camera) within the virtual space. In some implementations, the movement direction of the object can be determined as toward or away from the virtual camera. In some implementations, this direction can be determined based on the direction of the component of the object's movement that is along the axis intersecting the virtual camera and the object. Block 302 may be followed by block 304.

In block 304, it is determined whether the distance between the graphical object and the virtual camera has increased. The distance is determined to have either increased or decreased. For example, the distance may have increased if the object has moved away from the virtual camera and/or the virtual camera has moved away from the object, and the distance may have decreased if the object has moved toward the virtual camera and/or the virtual camera has moved toward the object. If the distance has decreased, then the method continues to block 350 of method 300b, described below with respect to FIG. 3B. If the distance has increased, then the method continues to block 306.

In block 306, it is determined whether the object is a 3D object and whether the 3D object is positioned at a 3D threshold boundary. The 3D threshold boundary is a particular boundary at which a 3D object can be changed or transitioned into another 3D object of different complexity, e.g., to reduce processing requirements to display the 3D object. In some implementations, the 3D threshold boundary can be a particular distance from the virtual camera and within the field of view of the virtual camera. For example, the 3D threshold boundary can be a spherical boundary having a center at the virtual camera and a radius equal to the particular distance from the virtual camera, a planar boundary at the particular distance, etc.

If the object is not a 3D object and/or is not positioned at the 3D threshold boundary, the method continues to block 312, described below. If the object is a 3D object and is positioned at the 3D threshold boundary, the method continues to block 308, in which a proxy 3D object is generated that corresponds to the 3D object and has lower complexity than the 3D object. In some examples, the lower complexity can include a mesh of the 3D object that can be retopologized so that it includes fewer nodes, rig connections, and/or polygons using any retopology techniques, to form a mesh for the proxy 3D object. The lower complexity can include reduced shading or animations, lower resolution textures on the mesh, etc. In some implementations, the proxy 3D object may have been previously created and stored, and can be retrieved from storage in block 308. Block 308 may be followed by block 310.

In block 310, the proxy 3D object is caused to be displayed in the virtual world in place of the 3D object. For example, the 3D object can be removed from the virtual world and the proxy 3D object displayed at the same location of the 3D object. Block 310 may be followed by block 302, in which the method continues to determine a location and direction of the graphical object (which is now the proxy 3D object) in the virtual space. For example, the graphical object and/or virtual camera may have moved based on user input to the virtual space and/or based on events or conditions occurring in the virtual space.

If the object is not a 3D object and/or is not positioned at the 3D threshold boundary as determined in block 306, the method continues to block 312, in which it is determined whether the object is a 3D object and whether the 3D object is positioned at (e.g., straddles) a transition boundary. The transition boundary is a particular boundary at which an object can be transitioned into an object that is displayed with a different number of spatial dimensions, and can be similar to the threshold boundary implementations described herein, e.g., for method 200 of FIG. 2. In this case, the graphical object is a 3D object that is moving away from the virtual camera, and the 3D object can be transitioned into a 2D object. In some implementations, the transition boundary can be a particular distance from the virtual camera that is greater than the distance of the 3D threshold boundary from the virtual camera as described above, and the transition boundary is within the field of view of the virtual camera.

If the graphical object is not a 3D object and/or is not positioned at the transition boundary, the method continues to block 318, described below. If the graphical object is a 3D object and is positioned at the transition boundary, the method continues to block 314, in which a 2D object that corresponds to the 3D object (or corresponds to one or more 3D objects that include the 3D object) is generated. The corresponding 2D object is generated based on the 3D object. For example, the corresponding object can be a 2D object (e.g., flat object having a bitmap thereon) that is generated from the 3D based on a view projection of the 3D object along the line of sight of the virtual camera using any of standard generation techniques. In various implementations, the 2D object can be generated directly from the 3D object that straddles the transition boundary, which may be a lower-complexity proxy 3D object as described above; or the 2D object can be generated directly from a stored, higher-complexity version of a proxy 3D object that straddles the transition boundary (e.g., the highest complexity version available).

In some implementations, if there are multiple 3D objects positioned at the transition boundary, it can be determined whether aggregation conditions are met. Aggregation conditions indicate whether the multiple 3D objects can be aggregated into a single aggregate object and a single (aggregate) 2D object can be generated therefrom. An aggregate 2D object represents multiple objects (e.g., multiple 2D objects that correspond to 3D objects) and can be considered a single 2D object for display, movement, and other interactions in the virtual space that represents all the aggregated objects. This allows multiple objects to be manipulated (e.g., generated, moved, displayed, etc. in the virtual space) with reduced processing requirements since the individual objects in the aggregated object do not need to be separately processed, compared to manipulating the multiple objects individually.

In some implementations, one or more heuristics can be used to determine whether to aggregate the multiple objects into a single aggregate object. For example, aggregation conditions can include determining if multiple 3D objects are present that are within a threshold distance of at least one of the other 3D objects. In some implementations, the aggregation conditions can include determined whether a threshold number of objects are present. For example, the threshold number of objects can be as small as two or can be larger, e.g., 10 or 100. In some implementations, aggregation conditions can include that the objects are moving at velocities that are close to each other, e.g., within a threshold velocity range of each other (e.g., magnitude, direction/trajectory, or both magnitude and direction/trajectory). In further examples, the conditions can include that the objects have a predetermined association with each other. For example, an attribute of an object may indicate whether that object is to be aggregated (grouped) with other objects, and/or can identify particular objects (e.g., via identifiers) that it may be aggregated with. In further examples, the conditions can include that the object is indicated to be a child object of a parent object (e.g., via an attribute as described above), such that the child object can be aggregated with the parent object. In some implementations, child objects are removed and are considered part of the parent object that remains in the virtual space.

In some examples, several 3D objects that represent avatars or characters may be positioned within a volume of a 3D object that represents a train or other vehicle. In this example, the aggregation conditions include that the objects to be aggregated have the same velocity, are within a threshold distance and velocity of each other, and have a predetermined association. In this case, the avatar objects are attributed as child objects of the parent vehicle object. Since all of the conditions are met, the vehicle object and the avatar objects are aggregated into a single object, that in this example is represented by the vehicle object.

In some implementations, if the aggregation conditions are met, the multiple 3D objects can be aggregated to create an aggregate 3D object, and an (aggregate) 2D object can be generated from the aggregate 3D object. In some implementations, multiple corresponding 2D objects can be generated from the multiple 3D objects and the multiple 2D objects can be aggregated into a single aggregate 2D object. The aggregate 2D object is generated to represent the multiple 3D objects in the virtual space, and requires reduced amount of processing to be generated, moved and displayed within the virtual space compared to multiple 2D objects that would otherwise be generated to correspond to the multiple 3D objects. In some implementations, the aggregate object can be one of the multiple objects that have been aggregated, which is selected to represent the multiple objects. For example, the largest of the multiple objects can be selected to represent the multiple objects. In some implementations, e.g., if one of the objects is a parent object to the other objects that are child objects, the parent object can be selected to represent the multiple objects. In some implementations or cases, the aggregate object can be generated as a new object that combines two or more of the multiple objects and/or portions of two or more of the multiple objects. For example, an aggregate object can be generated from two of the objects that are positioned contacting each other, from a combination of portions of the two objects contacting each other, etc. In some implementations, two or more aggregate objects can be generated, where each aggregate object includes different objects of the multiple objects. Block 314 may be followed by block 316.

In block 316, the 3D object(s) and the generated corresponding 2D object are displayed such that non-occluded portions of the 3D object and the corresponding 2D object are displayed. The 2D object is positioned at the transition boundary and/or in contact or adjacent to the 3D object, similarly as described above with respect to block 208 of method 200 of FIG. 2. For example, in some implementations, the 2D object is placed at the transition boundary where the 3D object is clipped, such that the 2D object is least partially within or in back of the 3D object, allowing a smoother visual transition from 3D object to 2D object to be provided if the 3D object continues to move away from the virtual camera.

Occluded portions of the 3D object and/or the corresponding 2D object are determined based on their locations in the virtual space relative to the virtual camera, similarly as described above for method 200 of FIG. 2. For example, in the view of the camera, the 3D object may be occluding one or more portions of the 2D object, and/or the 2D object may be occluding one or more portions of the 3D object. In some implementations, a depth attribute of the 2D object can be used to determine how much of and/or which portions of the 3D object are occluded. In some implementations, lines of sight can be traced from the camera to each portion of the 2D object to determine if a portion of the 3D object is positioned in front of the 2D object along that line. In some implementations, the occluded portions of the 3D object can be determined by, for example, determining which portions of the 3D object extend beyond the transition boundary, which may be considered the occluded portions (and/or these 3D object portions may be clipped or removed from the virtual space).

The non-occluded portions of the 3D object and the corresponding 2D object are displayed, e.g., caused to be rendered by a display device. The occluded portions of these objects, as determined above, are not displayed. For example, the 2D object may have been placed behind the 3D object, or through the middle of the 3D object, and may be mostly occluded by the 3D object. In some implementations, the transition boundary acts as a clipping surface for the 3D object, such that any portions of the 3D object that extend past the transition boundary (or past a particular point within a wider transition boundary) in a direction away from the virtual camera are clipped and not displayed.

In some implementations, the 3D object and the 2D object are updated at the same update rate, similarly as described above for method 200 of FIG. 2. In some implementations, the 2D object can have a lower update rate than the 3D object (when the 2D object is away from the transition boundary), thus providing a reduction in processing resources needed to update the 2D object in the virtual space compared to the 3D object. Block 316 can reduce the update rate of the 3D object to match the (lower) update rate of the 2D object while the 3D object and the 2D object are displayed concurrently (when straddling the transition boundary). In some implementations, while the 3D object and the 2D object are concurrently displayed (when at the transition boundary), the update rate of the 3D object can be reduced and the update rate of the 2D object can be set to a particular matching update rate that matches update rate of the 3D object, e.g., a transitional update rate that is between the standard update rate of the 3D object and the standard update rate of the 2D object (e.g., the standard update rates when these objects are located away from the transition boundary). In some implementations, the update rate of the 2D object can be increased to match the update rate of the 3D object while the 3D object and the 2D object are concurrently displayed (e.g., when straddling the transition boundary). In some of these implementations, the update rate of the 2D object can be reduced to its standard update rate when the 3D object is removed (e.g., if the objects move a threshold distance from the transition boundary in a direction away from the virtual camera). In some implementations, the update rate that is used as the matched rate can vary based on one or more conditions or characteristics of the objects. For example, if the 3D object has low fidelity, complexity, or resolution, the 3D object update rate can be reduced to the standard 2D object update rate (at which the 2D object also is updated), and if the 3D object has a higher fidelity/resolution, the matched update rate can be between the standard update rates of the 3D object and the 2D object. In some implementations, the 3D object and 2D object (and/or skybox object) can all be displayed at the same update rate at any location in the virtual space, e.g., at the transition boundary and away from the transition boundary.

In later iterations of method 300, the 3D object and the corresponding 2D object can be displayed concurrently based on block 316 while the 3D object straddles the transition boundary.

Block 316 may be followed by block 302, in which the method continues to determine a location and movement of the graphical object in the virtual space. For example, the graphical object and/or virtual camera may have moved based on user input to the virtual space and/or based on characteristics of the object (e.g., velocity), events or conditions occurring in the virtual space, etc.

If the 3D object does not straddle the transition boundary as determined in block 312, the method continues to block 318, in which it is determined whether the graphical object is positioned between the transition boundary (of block 312) and a skybox boundary (of block 324). An object positioned between these boundaries is generally a 2D object. If the object is not between these boundaries, the method continues to block 324, described below.

If the 2D object is between the boundaries, the method continues to block 320, in which the 2D object is displayed and, if the 3D object is being displayed, it is removed from the virtual space, thus leaving the corresponding 2D object to remain displayed as the graphical object in the virtual space at the increased distances to the virtual camera. In some implementations, block 320 is performed when the object has moved into the region between the boundaries just after moving beyond the transition boundary of block 312. In some implementations, the 3D object can be removed if it is no longer in contact the transition boundary, or is at a location that is a threshold distance away from the transition boundary.

In some implementations or cases, when multiple 2D objects are present in the region between transition and skybox boundaries, aggregation conditions can be checked, and if the conditions are met, aggregation of the multiple 2D objects into an aggregate 2D object may be performed, similarly as described above for block 314. Block 320 may be followed by block 302 to determine locations and/or movement of the graphical object.

If the object is not between the transition boundary and skybox boundary as

determined in block 318, the method continues to block 324, in which it is determined whether the object is at a skybox boundary (or beyond the skybox boundary in a direction away from the virtual camera). An object positioned at the skybox boundary is generally a 2D object (or in some implementations may be a 3D object). The skybox boundary is a particular boundary at which an object can be removed from the virtual space (e.g., no longer displayed in the virtual space), and the object is added to the skybox object that is displayed in the virtual space. This reduces processing and display requirements in the display of the object. The skybox object can be similar to the skybox object described above in method 200 of FIG. 2. The skybox boundary can be at a greater distance from the virtual camera than the transition boundary and is within the field of view of the virtual camera.

If the graphical object is not at or beyond the skybox boundary as determined in block 324, the method continues to block 332, in which the object is caused to be displayed. For example, the object is rendered in the virtual space on a display device. Block 332 may be followed by block 302, in which the method continues to determine a location and direction of the graphical object in the virtual space.

If the graphical object is at or beyond the skybox boundary as determined in block 324, the method continues to block 326, in which the graphical object is incorporated into a skybox portion of the skybox object and is cached. For example, if the graphical object is not yet incorporated in the skybox object, then it is incorporated into the skybox portion and is cached. If the graphical object is already incorporated in the skybox object (e.g., in the same location of the skybox portion) as in the previous iteration of method 300, then block 326 can be skipped and the skybox object continues to be maintained at that location (and was previously cached). In some implementations, the skybox object can generally be displayed at a lower update rate than the corresponding 3D object and the corresponding 2D object, thus providing a reduction in processing resources needed to display the skybox object compared to these objects. In some implementations, the skybox object can be displayed at the same update rate as the corresponding 2D object (which can be lower than the update rate of the corresponding 3D object(s), in some implementations).

The associated skybox portion in which the graphical object is incorporated can, in some implementations, be selected as one portion of multiple skybox portions of the entire skybox object. For example, the skybox object can be divided into portions that cover its entire area as described above for method 200 of FIG. 2. In some implementations, the skybox portion can be the entire skybox object, e.g., there is only one skybox portion that covers the entire area of the skybox object. In some implementations, the 2D object is incorporated into an associated skybox portion similarly as described above for method 200 of FIG. 2 (e.g., a skybox portion that encompasses an area at the skybox boundary that is intersected by the 2D object).

In some implementations, the 2D object that is newly incorporated into the skybox portion can be cached in an object cache. For example, the cached 2D object can be retrieved to be used in a display of the skybox object, or can be retrieved when it is to be displayed as a 2D object outside of the skybox object. In some implementations, the 2D object can be stored in association with one or more 3D object versions of the graphical object.

In some implementations, the 2D object may have previously been incorporated into the associated skybox portion and has moved within the skybox region such that it is in a different area of the associated skybox portion, and in such a case, the associated skybox portion can be updated to remove the skybox object from its old location (e.g., by retrieving, e.g., from the cache, an earlier version of the skybox portion that does not include the 2D object) and adding the 2D object (e.g., retrieved from the cache) to the new location in the associated skybox portion. In some implementations, when a skybox 2D object moves such that it is in a new, different skybox portion, the previous skybox portion can be updated to remove the 2D object and the new skybox portion can be updated to incorporate the 2D object.

In some implementations, the associated skybox portion, that has been modified by inserting the 2D object into the portion image, can be cached or otherwise stored in a skybox portion cache (also, if applicable, a previous skybox portion from which the 2D object has been removed is also cached or designated as the latest version of that skybox portion). The skybox portion cache can store versions of the skybox portions of the skybox object that have been modified based on adding, removing, or moving 2D objects in the skybox portions. The skybox portion cache allows previously generated portions of the skybox object stored in the cache to be retrieved for display without having to generate those portions again.

In some implementations, the 2D object that is incorporated into the skybox portion can be tracked, e.g., the location of the 2D object within the skybox object can be stored (e.g., with an identification of the particular skybox portion, coordinates or other location with reference to the skybox portion boundaries, etc.). The 2D object can be tracked while it is incorporated in the skybox portion.

In some implementations, two or more skybox 2D objects can be aggregated into an aggregate skybox 2D object. For example, 100 close by tree objects in the skybox portion can be aggregated into a single aggregate 2D object in the associated skybox portion. In some implementations, the newly-incorporated 2D object can be added to such an aggregate object, or can be included in a newly formed aggregate object, if one or more aggregation conditions are met. For example, the aggregation conditions can include that the new 2D object is close in location, is similar in type, has a pre-existing association with, etc. to one or more existing 2D objects or aggregate 2D object(s). The aggregate object can be manipulated as a single representative 2D object in the skybox portion, e.g., can be removed from the skybox as a single object, thus reducing processing requirements to manipulate the objects.

In some implementations, the skybox cache(s) can be organized in a hierarchical fashion. For example, each skybox portion can be associated with a respective hierarchy of 2D objects incorporated within that portion. At the bottom level of the hierarchy, individual 2D objects can be tracked (e.g., their locations, attributes, sizes, etc. stored). At the next higher level of the hierarchy, aggregate 2D objects can be stored, e.g., an aggregate 2D object that is composed of particular 2D objects at the lower level. Higher hierarchical levels can each include aggregate 2D objects that are composed of aggregate 2D objects at the next lower level.

In some implementations, one or more skybox portions of the skybox object can be aggregated into an aggregate skybox portion. For example, two adjacent skybox portions can be aggregated into a single aggregate skybox portion in the skybox object. In some implementations, a skybox portion in which received the newly-incorporated 2D object can be added to such an aggregate skybox portion, or can be included in a newly formed aggregate portion, if one or more portion aggregation conditions are met. For example, the aggregation conditions can include that the aggregated skybox portions be close in location (e.g., adjacent), or have incorporated associated 2D objects. The aggregate skybox portion can be manipulated as a single skybox portion, e.g., can be retrieved from a cache and displayed as a single object, thus reducing processing requirements to manipulate the skybox portions.

For example, a skybox portion cache can store aggregate portions that are composed of multiple skybox portions. Such a cache can be organized hierarchically, similarly as described above for the skybox portion cache. For example, at the bottom level of the hierarchy, individual skybox portions can be tracked (e.g., their locations, attributes, etc. stored). At the next higher level of the hierarchy, aggregate skybox portions can be stored, e.g., an aggregate skybox portion that is composed of particular skybox portions at the lower level. Higher hierarchical levels can each include aggregate skybox portions that are composed of aggregate skybox portions at the next lower level.

In some implementations, various versions of skybox portions can be cached. For example, most recent version of a skybox portions can include one or more incorporated 2D objects. Older versions of the skybox portion may include fewer of the 2D objects, and the oldest version can be the original unmodified skybox portion. Block 326 may be followed by block 328.

In block 328, one or more skybox portions are retrieved from skybox portion cache(s) (or other storage). These skybox portions, along with the updated skybox portion of block 326, constitute the entire displayed area of the skybox object in the virtual space. These skybox portions include other skybox portion(s) that have been cached. In some implementations, the other skybox portions were cached when the skybox object was created or when other skybox portions were updated with other 2D objects being added or removed from those skybox portions. The latest versions of the other skybox portions that form the skybox object can be retrieved, which may or may not include one or more incorporated 2D objects. Skybox portions of the skybox object that are not in the field of view of the virtual camera can be skipped in the retrieval.

In some cases or implementations, one or more 2D skybox objects can also or alternatively be retrieved from the skybox caches. These objects can be other 2D objects that have been incorporated in skybox portions, e.g., in the same associated skybox portion that the current 2D object was incorporated into in block 326. If these other 2D objects have not changed (e.g., have not moved out of the skybox object and closer to the camera), then the cached versions of these objects can be retrieved and do not need to be regenerated.

In some implementations, as described above, aggregate skybox 2D objects may be stored that include (or refer to or are associated with) multiple skybox 2D objects, and/or aggregate skybox portions may be stored that include (or refer to or are associated with) multiple skybox portions, and one or more of these aggregate objects and/or portions can be retrieved in block 328. Such aggregated objects and skybox portions can reduce the amount of skybox objects and portions to be manipulated and thus reduce required processing operations. For example, an aggregated skybox 2D object can be retrieved that is composed of the incorporated 2D object and one or more other 2D skybox objects, and the aggregated skybox 2D object is pasted in the updated skybox portion. In another example, an aggregated skybox portion can be retrieved that is composed of four adjacent skybox portions of the skybox object. In further examples using a hierarchical aggregated object structure as described above, a skybox portion that is updated can be retrieved from the lowest hierarchical level that stores individual skybox portions, and multiple other skybox portions that are not being updated can be retrieved in higher level aggregated skybox portions that include (or refer to) the other skybox portions. Block 328 may be followed by block 330.

In block 330, an updated skybox object is displayed that includes the updated and retrieved skybox portions, and the graphical object (e.g., 2D object) is removed from the virtual space since it is included in the associated skybox portion. For example, the skybox object can be composited from the updated skybox portion that includes the 2D object as generated in block 326 and can include other 2D objects retrieved from the cache in block 218. The updated skybox object also includes the other skybox portions retrieved in block 328. The updated skybox object can be displayed by a display device that is displaying the virtual space, e.g., in a virtual experience. Block 330 may be followed by block 302, in which the method continues to determine a location and movement of the graphical object in the virtual space.

FIG. 3B is a flow diagram illustrating method 300b that is a portion of method 300 and continues the method 300a of FIG. 3A to display levels of detail of 2D and 3D objects in a virtual space, in accordance with some implementations. Method 300b can be performed if the distance between the graphical object and the virtual camera has decreased as determined in block 304 of FIG. 3A. Method 300b may begin at block 350.

In block 350, it is determined whether the object is at or beyond the skybox boundary. As described with reference to method 300 of FIG. 3, the object is generally a 2D object if it positioned at the skybox boundary (or beyond the skybox boundary in a direction away from the virtual camera). If the graphical object is not at or beyond the skybox boundary, the method continues to block 358, described below. If the graphical object is at or beyond the skybox boundary as determined in block 350, the method continues to block 352, in which the object is incorporated into an associated skybox portion of the skybox object, if the graphical object was not already incorporated in the skybox object. If the object is already incorporated in the skybox object (e.g., in the same location of the skybox portion as in the previous iteration of method 300), then blocks 352 can be skipped and the skybox object can continue to be maintained at that location.

In some implementations or cases, the 2D object may have been previously incorporated into the associated skybox portion and has moved such that it is in a different area of the associated skybox portion. In such a case, the associated skybox portion is updated to remove the skybox object from its old location (for example, by retrieving, e.g., from the cache, an earlier version of the associated skybox portion that does not include the 2D object) and add the 2D object to the skybox portion at its new location. In some implementations or cases, the 2D object has moved such that it is in a different (e.g., adjacent) skybox portion, in which case the previous skybox portion can be updated to remove the 2D object and the new skybox portion is updated to incorporate the 2D object.

The associated skybox portion, that has been modified by inserting the 2D object into the portion image, is cached or otherwise stored in a skybox portion cache (also, if applicable, a previous skybox portion from which the 2D object has been removed is also cached or designated as the latest version of that skybox portion), similarly as described above for block 326. In some implementations, 2D objects in skybox portions (“2D skybox objects”), and/or skybox portions, can be cached, tracked, and/or included in aggregated objects as described above. Block 352 may be followed by block 354.

In block 354, one or more other skybox portions are retrieved from skybox portion cache(s) (or other storage). These skybox portions, along with the updated skybox portion of block 352, constitute the entire displayed area of the skybox object in the virtual space. These skybox portions (and/or 2D skybox objects) can be retrieved similarly as described above for block 328. Block 354 may be followed by block 356.

In block 356, an updated skybox object is displayed that includes the skybox portions. For example, the skybox object can be composited from the updated skybox portion as generated in block 352, and the other skybox portions retrieved in block 354. The updated skybox object can be displayed by a display device that is displaying the virtual space, e.g., in a virtual experience. Block 356 may be followed by block 302 of FIG. 3A, in which the method continues to determine a location and movement of the graphical object in the virtual space.

If the graphical object is determined in block 350 to not be positioned at or beyond the skybox boundary, block 358 is performed, in which it is determined whether the graphical object is positioned between the transition boundary and the skybox boundary. An object positioned between these boundaries is generally a 2D object. If the object is not between these boundaries, the method continues to block 364, described below.

If the graphical object is positioned between the transition and skybox boundaries, block 360 is performed, in which the 2D object(s) for the graphical object are obtained if the object has moved into this region between the boundaries after being incorporated in the skybox object as described above. In some cases, the 2D object is cached or otherwise stored, e.g., when it was incorporated into the skybox object as in block 326 or block 352, and the stored 2D object can be retrieved. In some implementations, e.g., if the 2D object is not stored, the 2D object can be generated. For example, the 2D object can be an image that is a copied portion of the skybox object that can be located within an associated skybox portion based on a stored location of the 2D object.

In some implementations, if the 2D object is an aggregated object that includes multiple 2D objects as described above, then the multiple objects can be determined and the object that represents the multiple objects is obtained for display. In some implementations, if two or more 2D objects are present in the region between boundaries, and aggregation conditions are met, the two or more 2D objects can be aggregated into an aggregated object similarly as described above for block 314.

In addition, if the 2D object has left the skybox object, the associated skybox portion that previously incorporated the 2D object(s) of block 360 can be updated to remove the 2D object(s) from that skybox portion. For example, a recent cached version of the associated skybox portion that does not include the 2D object can be retrieved. In addition, other skybox portions that do not need updates can be retrieved from the cache. Block 360 may be followed by block 362.

In block 362, the 2D object(s) determined in block 360 are displayed. In addition, the updated skybox is displayed, including the updated skybox portion that does not include the 2D object(s), as well as the other skybox portions that have not been updated. For example, in some implementations, the various skybox portions can be combined into a single skybox object for display; in other implementations, the skybox portions can be independently displayed. After block 362, the method may continue to block 302 to determine locations and/or movement of the graphical object.

If the object is not between the transition boundary and skybox boundary as determined in block 358, the method continues to block 364, in which it is determined whether the graphical object is positioned at (e.g., straddles) the transition boundary. In this case, the graphical object is a 2D object that is moving toward the virtual camera, and the 2D object can be transitioned into a 3D object. The transition boundary can be the same transition boundary described above with reference to block 312. In some implementations, the transition boundary of block 358 can be similar to the transition boundary of block 312, e.g., located at the same location as the transition boundary of block 312, or located a different distance from the virtual camera than the transition boundary of block 312.

If the object is not a 2D object and/or is not positioned at the transition boundary, the method continues to block 372, described below. If the object is a 2D object and is positioned at the transition boundary, the method continues to block 368, in which a 3D object that corresponds to the 2D object is obtained. In some cases, the corresponding 3D object is obtained from a cache, e.g., in which the corresponding 3D object is stored in association with the 2D object (e.g., a most-recently displayed version of the 3D object may have been stored in the cache when it was replaced by the 2D object in the region between transition and skybox boundaries). In some implementations, multiple versions of the 3D object having different complexities are provided, and, for example, the 3D object having the lowest complexity can be obtained in block 368. In some implementations or cases, the corresponding 3D object can be generated based on the 2D object. For example, the 3D object can be generated based on stored 3D descriptive data for the 3D object, or if no such data is available, by extruding the 2D object along a third dimension. The obtained 3D object is positioned at the transition boundary aligned with the 2D object in the virtual space, e.g., aligned with a line of sight from the camera to the 2D object. In some examples, when the 3D object is initially displayed at the transition boundary, the 3D object can be positioned such that a particular edge or portion contacts the transition boundary, e.g., an edge or portion that closest to the camera, furthest from the camera, etc.

In some implementations, if the 2D object is an aggregated 2D object that represents multiple objects, a corresponding aggregated 3D object can be obtained and/or generated, e.g., if the aggregation condition(s) exist as described above for block 314. For example, if one of the objects is considered a parent object and the other objects are child objects of the parent object, the parent object can be obtained or generated without generating or obtaining the child objects. In some implementations, all the multiple 3D objects in the aggregated 2D object, or a subset thereof, can be obtained or generated. Block 368 may be followed by block 370.

In block 370, the obtained corresponding 3D object is displayed at the location of the 2D object such that non-occluded portions of the 2D object and the corresponding 3D object are displayed. The 3D object can be positioned relative to the 2D object similarly as described above and/or for block 316 of FIG. 3A or block 208 of FIG. 2. For example, in some implementations, the 3D object is positioned along a view axis that extends from the virtual camera and intersects the 2D object, so that the 3D object is aligned with the 2D object in the field of view of the virtual camera, e.g., at least partially in front of the 2D object as viewed by the virtual camera.

An occluded portion of the 2D object and an occluded portion of the corresponding 3D object are determined based on their locations in the virtual space relative to the virtual camera, similarly as described above for block 316 and for method 200 of FIG. 2. In some implementations, a depth attribute of the 2D object can be used to determine how much of and/or which portions of the 3D object are occluded. The non-occluded portions of the 3D object and the corresponding 2D object are displayed, e.g., caused to be rendered by a display device. The occluded portions of these objects, as determined above, are not displayed. For example, the 3D object may have been added such that it is in front of and at least partially occludes the 2D object. In some implementations, the 3D object and the 2D object are rendered at the same update rate similarly as described above.

Similarly as described above with reference to block 316, in some implementations the 3D object can be displayed at a higher update rate than the 2D object. In block 370, the update rate of the 3D object can be reduced from its standard update rate to match the update rate of the 2D object while the 3D object and the 2D object are displayed concurrently (when straddling the transition boundary). The update rate of the 3D object can be increased to its standard update rate when the 2D object is removed (e.g., when the object moves out of contact with, or at least a threshold distance from, the transition boundary in a direction toward the virtual camera). In some implementations, while the objects are currently displayed at the transition boundary, the update rate of the 3D object can be reduced by a particular amount and the update rate of the 2D object can be increased to a particular matching update rate; or the update rate of the 2D object can be increased to match the standard update rate of the 3D object; and/or the update rate that is used as the matched rate can vary based on one or more conditions or characteristics of the objects similarly as described above.

In subsequent (later) iterations of method 300, the 2D object and the corresponding 3D object can be displayed concurrently based on block 370 while the 2D object and/or 3D object straddle the transition boundary, e.g., until one or more of the objects are no longer straddling or no longer contact the transition boundary (and/or are a threshold distance away from the transition boundary). At this point, if the distance between camera and the objects has continued to decrease, the 2D object can be removed from the virtual space, leaving the corresponding 3D object to remain as the graphical object in the virtual space at the lower distances to the virtual camera.

Block 370 may be followed by block 302, in which the method continues to determine a location and movement of the graphical object in the virtual space.

If the 2D object does not straddle the transition boundary as determined in block 364, the method continues to block 372, in which it is determined whether the object is a 3D object and whether the 3D object is positioned at a 3D threshold boundary. As described above for block 306, the 3D threshold boundary is a particular boundary at which a 3D object can be changed into another 3D object, e.g., to reduce processing requirements to display the 3D object. In some implementations, multiple 3D threshold boundaries can be provided, e.g., at different distances from the virtual camera. In various implementations, the 3D boundaries of block 372 can be the same as the corresponding 3D boundaries in block 306, or the corresponding boundaries can be different distances to the camera.

If the object is not a 3D object and/or is not positioned at the 3D threshold boundary, the method continues to block 378, described below. If the object is a 3D object and is positioned at the 3D threshold boundary, the method continues to block 374, in which a complex 3D object is generated that corresponds to the 3D object and has higher complexity than the 3D object. For example, a more complex version of the 3D object can be obtained from storage where the complex 3D object is stored (e.g., cached at an earlier iteration, e.g., block 308 of FIG. 3). Block 374 may be followed by block 376.

In block 376, the complex 3D object is caused to be displayed in the virtual space in place of the 3D object. For example, the 3D object can be removed from the virtual space and the complex 3D object displayed at the same location of the 3D object. Block 376 may be followed by block 302, in which the method continues to determine a location and direction of the graphical object (which is now the complex 3D object) in the virtual space.

If the graphical object is not a 3D object at a 3D threshold boundary as determined in block 324, the method continues to block 378, in which the object is caused to be displayed. For example, the object is rendered in the virtual space on a display device. Block 378 may be followed by block 302, in which the method continues to determine a location and direction of the graphical object in the virtual space.

In various implementations, various blocks of method 300 may be combined, split into multiple blocks, performed in parallel, or performed asynchronously. In some implementations, one or more blocks of these methods may not be performed or may be performed in a different order than shown in these figures. Method 300, or portions thereof, may be repeated any number of times using additional inputs.

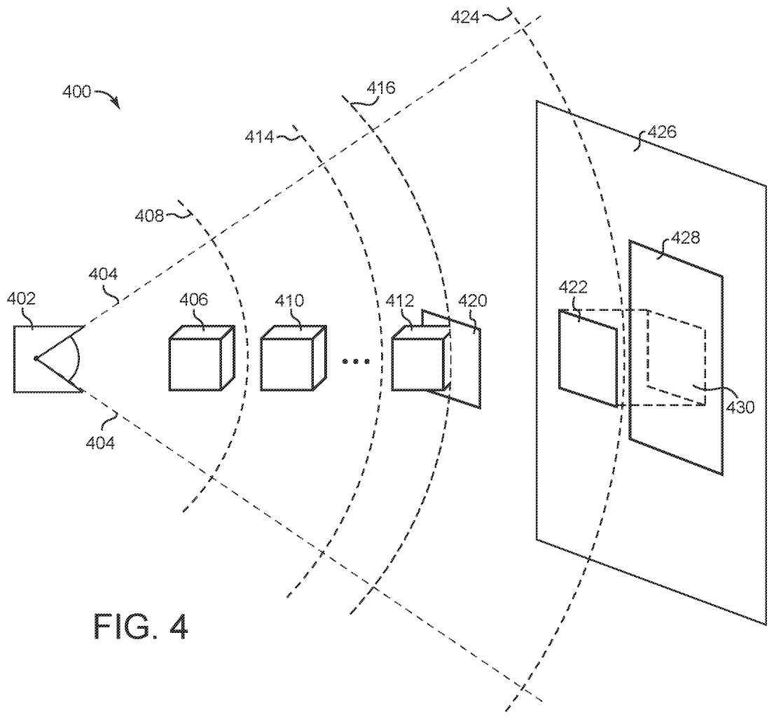

FIG. 4 is a diagrammatic illustration of graphical objects displayed at different levels of detail in a virtual space 400, in accordance with some implementations.

A virtual camera 402 is located in virtual space 400 and has a field of view 404 as indicated by the dashed lines. In this example, a graphical object is shown in various different levels of detail based on the distance of the graphical object from virtual camera 402, and as described with reference to method 300 of FIGS. 3A-3B.

The graphical object is displayed as a 3D object 406 that is located close to virtual camera 402, e.g., on the near side of a first 3D threshold boundary 408. 3D object 406 has a high level of detail for the graphical object, e.g., it is the version of the 3D object having the greatest amount of 3D geometric complexity (e.g., the most polygons and/or other geometrical or texture features) for the graphical object of the 3D objects available to represent the graphical object. First 3D threshold boundary 408 is shown as spherical, but can be planar or otherwise shaped in other implementations. Boundary 408 can extend all the way around virtual camera 402, but is relevant for display purposes within the field of view 404 of the virtual camera.

The graphical object can be displayed at a location in the virtual space that is further from the virtual camera 402 than the location of 3D object 406. For example, the graphical object can be displayed at a location that is at or beyond the first 3D threshold boundary 408, shown as a 3D object 410 in FIG. 4. 3D object 410 is a proxy 3D object that has a lower complexity than the higher-complexity 3D object 406 and has replaced the higher complexity object to reduce display processing. It is further away from the camera 404 and the lower level of detail is not as visible to the camera.

The graphical object can be displayed at locations further from the virtual camera 402 than the location of 3D object 410. One or more additional 3D threshold boundaries can be provided at further distances from virtual camera 402, such that the graphical object is represented by a 3D object having lower complexity at each successive 3D threshold boundary. For example, the graphical object is represented by 3D object 412 that is positioned at a location past a second 3D threshold boundary 414 in a direction from left to right in FIG. 4. 3D object 412 is a proxy 3D object that has a lowest complexity of the 3D objects, and has replaced the higher-complexity 3D object 410 in the virtual space to reduce display processing of the graphical object.

3D object 412 is positioned at a location that contacts or straddles a transition boundary 416. At this boundary, as described above, a 2D version of the graphical object is generated as 2D object 420 based on the 3D object (of any version) and is displayed concurrently with the 3D object 412. In this example, 2D object 420 has been generated based on 3D object 412 and the 2D object is displayed at the transition boundary 416, e.g., aligned on a line of sight extending through the 3D object 412 and virtual camera 402. 2D object 420 is shown in FIG. 4 being positioned in back of 3D object 412 with respect to virtual camera 402, and 3D object 412 is shown being clipped by transition boundary 416 such that its further portion is removed. Alternatively, 2D object can be positioned at a different location relative to 3D object 412, e.g., at the middle of 3D object 412.

3D object 412 and 2D object 420 are displayed such that non-occluded portions are displayed and occluded portions are not displayed. For example, 3D object 412 is in front of most of 2D object 420 and thus occludes the portions of 2D object 420 that it is in front of. The occluded 2D object portions are not displayed. Portions of 2D object 420 that are not occluded by 3D object 412, such as left and right portions of 2D object 420 extending beyond the occluding shape of 3D object 412, are displayed. The 3D object and 2D object have the same update rate so that the occluded portions of 2D object 420 remain occluded at all times during the concurrent display of objects 412 and 420.

The graphical object can also be displayed at locations that are further from the virtual camera 402 and the transition boundary 416, shown in this example as 2D object 422, when 3D object 412 is removed from the virtual space. The 2D object 422 can have a lower update rate in these further locations up to skybox boundary 424.

The graphical object can be displayed at a furthest location from the virtual camera 402 that is defined by a skybox threshold boundary 424. At such a location, the graphical object is incorporated into a skybox object 426. For example, the 2D object 422 can be incorporated into a skybox portion 428 that is a portion of skybox object 426, where the portion 428 can be aligned with 2D object 422 and virtual camera 402. In some implementations, skybox object 426 can include multiple portions, each similar to portion 428.

At the skybox boundary, 2D object 422 is pasted into a corresponding area 430 of skybox portion 428, thus becoming part of the skybox portion 428 and skybox object 430.

In some example implementations of the various methods described herein, for forward and deferred rasterization types of rendering, 3D and 2D portions can be rendered separately and composited, and a static skybox object can be rendered with separate skybox portions and/or 2D objects in a similar way. For ray tracing, rays that hit the skybox boundary can directly reference a lookup table (e.g., similar to a cube map lookup table) to determine the pixels to be displayed, e.g., in a dynamic skybox object (which can also be performed for a static skybox).

Update rates of the graphical object can vary at different distances from virtual camera 402. In general, the update rate can be reduced for further distances from the virtual camera, e.g., to reduce and save processing resources such as memory, computational processing, data bandwidth, etc. For example, 3D objects 406 and 410 can have a high update rate since they are close to the virtual camera. In some implementations, 3D object 410 can have a lower update rate than 3D object 406 since 3D object 410 is further from the virtual camera. At transition boundary 416, 3D object 412 and 2D object 420 can have the same update rate that is lower than the update rate of 3D objects 406 and 410. 2D object 422, which is positioned further than transition boundary 416, can have an update rate lower than the update rate of 3D object 412 and 2D object 420 at the transition boundary. Skybox object 426 and skybox portion 428 can have the lowest of these update rates, e.g., lower than the update rate of 2D object 422.

FIG. 5 is a flow diagram illustrating a method 500 to update a location of a transition boundary in a virtual space that determines a level of detail of displayed objects, in accordance with some implementations. In some implementations, method 500 can be performed concurrently with method 200 or 300. In some implementations, method 500 can be implemented, for example, on a server system, e.g., online metaverse platform 102 as shown in FIG. 1. In some implementations, method 500 can be performed at least in part by metaverse engine(s) 104 of online metaverse platform 102. In some implementations, some or all of the method 500 can be implemented on a system such as one or more client devices 110 and 116 as shown in FIG. 1, and/or on both a server system and one or more client systems. For example, in some implementations, method 500 can be performed at least in part by metaverse application(s) 112 of client devices 110, 116. In described examples, the implementing system includes one or more processors or processing circuitry, and one or more storage devices such as a database, data structure, or other accessible storage. In some implementations, different components of one or more servers and/or clients can perform different blocks or other parts of the method 500. Method 500 may begin at block 502.

In block 502, movement of the virtual camera from a first location to a second location in the virtual space is determined. For example, the movement can be caused by user input, events or conditions occurring in the virtual space, interactions with objects in the virtual space, etc. For example, if the virtual camera is associated with a user-controlled avatar in the virtual space, the virtual camera may have moved based on user input that moves the avatar (e.g., walking, running, falling, etc.). Block 502 may be followed by block 504.

In block 504, it is determined whether the movement determined in block 502 is within a play region associated with a transition boundary. The transition boundary can be any of the transition boundaries described herein. The play region allows a designated amount of free movement of the virtual camera that does not cause the associated transition boundary to move in accordance with the virtual camera. In some implementations, the play region can be a region (e.g., a spherical or other shaped region) defined by a particular radius or distance from the virtual camera. The play region is defined (e.g., centered) at the first location of the virtual camera, and the movement of the virtual camera is relative to that play region that remains stationary relative to the virtual camera. Movement within the play region is indicated by movement that does not cross the border of the play region, e.g., movement that does not cause the virtual camera to move to a location that is beyond the radius distance of the play region.

If the movement is within the play region, the method continues to block 506, described below. If the movement is at least partially outside the play region, the method continues to block 508.

In block 506, after determining in block 504 that the movement of the virtual camera is within the play region, the location of the transition boundary is maintained at its same location that is based on (relative to) the first location of the virtual camera, e.g., the transition boundary is not moved in accordance with the virtual camera. The virtual camera can move within the play region while the transition boundary remains fixed, which can reduce the amount of updates needed for any objects that straddle the transition boundary. This feature can reduce the expenditure of processing resources that could be wastefully used to update the transition boundary and potentially update objects close to the transition boundary for minor movements of the camera.

In some implementations, if the transition boundary updates are not reduced as described herein, there may be flickering of a displayed object when the camera moves a small distance such that the transition boundary slightly contacts the object, e.g., causing the object to continuously transition from a 2D object to a 3D object and vice-versa. In some implementations, in addition to or alternatively to the updates as described above, the update of the transition boundary in accordance with camera movement can performed only at every particular number of time units or frames during movement of the camera. The method continues to block 502 to determine the movement of the virtual camera.

In block 508, after determining in block 504 that the movement of the virtual camera is at least partially outside the play region of the transition boundary, the location of the transition boundary is updated based on the second location of the virtual camera (e.g., the location of the virtual camera after its movement). For example, the transition boundary (and play region) can be re-centered on the second location of the virtual camera. In some examples, if the virtual camera is determined to have moved 2 distance units in a particular direction past the play region boundary, the transition boundary is also moved that same distance and direction to become centered on the virtual camera. The method continues to block 502 to determine the movement of the virtual camera.

In some implementations, the play region can include a first play region when the virtual camera moves toward one or more objects, and a second play region when the virtual camera moves away from the one or more objects, where the first play region has a different size or radius than the second play region. For example, the first play region can have a larger radius and is used when transitioning from 2D objects to corresponding 3D objects, and the second play region can have a smaller radius and is used when transitioning from 3D objects to corresponding 2D objects; or the sizes may be reversed from this example. Such different play region sizes may, for example, reduce a flickering display effect caused by having the same transition boundary used in both directions, by reducing continuous transitions from 3D to 2D objects and back again.

In some implementations, any other boundary described herein, e.g., with reference to FIGS. 2 and 3, can have a play region similarly to the transition boundary described above. For example, the 3D threshold boundary (or multiple such boundaries if used), the transition boundary, and/or the skybox boundary can be maintained in their previous locations or moved with the virtual camera as described above in blocks 502-508.

FIGS. 6A and 6B are diagrammatic illustrations of movement of a virtual camera and transition boundary in a virtual space 600 according to the method of FIG. 5, in accordance with some implementations.

In FIG. 6A, a virtual camera 602a is located in virtual space 600 and has a field of view 604. A transition boundary 606a is located a particular distance from the center of the virtual camera 602a, similarly as described above for method 300. A play region 608a is a spherical region that is centered on the center of virtual camera 602.

In this example, as indicated by arrow 610, virtual camera 602a is moved to the right (e.g., based on user input) from its first location at 602a to a second location, where it is shown as virtual camera 602b. This movement causes virtual camera 602b to remain within play region 608a, and thus transition boundary 606a is not moved and remains at the same location associated with the first location of the virtual camera 602a.

In FIG. 6B, virtual camera 602b is shown in dashed lines since it has been moved further to the right to a third location in virtual space 600, where it is shown as virtual camera 602c. Virtual camera 602c is at least partially outside play region 608a. Thus, the movement shown by virtual camera 602c causes the transition boundary to move to a location in accordance with virtual camera 602c. For example, transition boundary 606a has been moved to a location to the right, shown as transition boundary 606b. The location of virtual camera 602c also causes the play region to move to a location in accordance with virtual camera 602c. For example, play region 608a has been moved to a location to the right, shown as play region 608b, which is centered on virtual camera 602c. The motion allowed by a virtual camera within a play region allows the transition boundary to be updated less frequently (e.g., updated only when the virtual camera moves to a location at least partially outside the current play region), thus saving processing resources.

In some implementations, other boundaries used in method 300 can be moved similarly to the transition boundary shown in FIGS. 6A-6B. In some implementations, different boundaries can be associated with differently-sized and/or differently-shaped play regions. For example, the skybox boundary can be associated with a larger play region (e.g., having a larger radius from the virtual camera) than the transition boundary.

Choosing the radius or distance between the virtual camera and the transition boundary may be important for hiding transition and sampling artifacts. The reduction or elimination of parallax related artifacts can be desirable when transitioning from the 3D object to the 2D object. In some implementations, the radius of the transition boundary can be set so that an object transitions from 3D object to 2D object when its footprint on the display approaches a single pixel.

In some implementations, the transition boundary may have a location (e.g., a radius or distance from the camera) and/or width (e.g., a span or range of distances from the camera at which the boundary is in effect) that can vary based on one or more characteristics of the graphical object. For example, the boundary location and/or width can be based on the maximum velocity of an object, e.g., to account for fast moving objects straddling the transition boundary. For example, a fast moving first object may be associated with a transition boundary having a large width, such that the first object is considered to straddle the transition boundary if any portion of the first object is positioned anywhere between 3 to 5 distance units from the camera. In contrast, a slower-moving second object may be associated with a transition boundary that has a smaller width, such that the second object is considered to straddle the transition boundary if any portion of the second object is positioned anywhere between 3 to 4 distance units from the camera (a smaller span of distance than for the first object).

In some implementations, the generation of 2D objects from a 3D object or from the 2D skybox to a 3D virtual space may cause samples from the 2D objects that are bilinearly interpolated to suddenly appear “sharper” when directly rendered in the 3D virtual space. This is a resampling issue and may occur with mipmap transitions as well in traditional texture Levels of Detail. Various methods for concealing this resampling can be used. In one method, if rendering with distance based, obscuring visual effects such as Depth of Field or Atmospheric Perspective, then the transition may be obscured. In another method, if using post-processed anti-aliasing and supersampling methods (e.g., temporal anti-aliasing (TAA) techniques), then the post processing can also smooth the transition and remove aliasing. In another method, e.g., for all other cases, the 2D object can be supersampled. For example, the 2D object can be generated at twice the resolution that the image will appear on the display device, and then bilinear or bicubic interpolation can be used when resampling to the display. Because the Nyquist criterion is preserved by this explicit supersampling, the result balances (e.g., simultaneously minimizes) both aliasing and blurring. For example, this can be similar to trilinear mipmapping for material Level of Detail (LoD) with a default setting of 0.5 bias on the MIP level lookup.

Data structures that can be used in one or more described implementations can include a skybox object (e.g., cube skybox or other shaped object, cube map, etc.) for all distant objects, a set of skybox portions from which the skybox object can be quickly regenerated, and an array of different versions of each 3D object at different levels of detail, which can be used for direct 3D rendering and for generating corresponding 2D objects.

Additional example implementations of one or more features described herein can include the following.

A method can include obtaining multiple 2D objects to be displayed in a virtual space; determining that the multiple 2D objects are positioned at or beyond a particular boundary within the virtual space, wherein the particular boundary is at a particular distance from a virtual camera for the virtual space, the virtual camera providing a displayed view of the virtual space; in response to determining that the 2D object is positioned at or further than the particular boundary, grouping the multiple 2D objects into a single aggregate 2D object; and causing the aggregate 2D object to be displayed in the virtual space instead of individually displaying the multiple 2D objects. In some implementations, the particular boundary is a skybox boundary, and the aggregate 2D object is incorporated into a skybox portion that is a portion of a skybox object. In some implementations, the boundary can be a transition boundary, and the aggregate 2D object is positioned between the transition boundary and a skybox object that is at the furthest distance from the virtual camera. In some implementations, aggregate 2D objects can be stored in a hierarchy in which the lowest level includes individual multiple 2D objects and higher levels include aggregate 2D objects that include the lower level individual 2D objects and/or lower level aggregate 2D objects.

In some implementations, a method can include grouping 3D objects into an aggregate 3D object and generating a 2D object from the aggregate 3D object. In some implementations, a method can include generating 2D object for each of multiple 3D objects and aggregating the multiple 2D objects into an aggregate 2D object. In some implementations, a method can include displaying a 2D object in a virtual space; caching the 2D object; determining that the 2D object is positioned at or further than a skybox boundary within the virtual space; in response to determining that the 2D object is positioned at or further than the skybox boundary, incorporating the 2D object into a skybox portion that is a portion of a skybox object; and updating the display of the skybox object including the skybox portion. In some implementations, a method can include updating and displaying a first subset of incorporated 2D objects as portions of a skybox object; and obtaining a second subset of cached 2D objects from the cache and displaying the cached 2D objects as skybox portions in the skybox object.

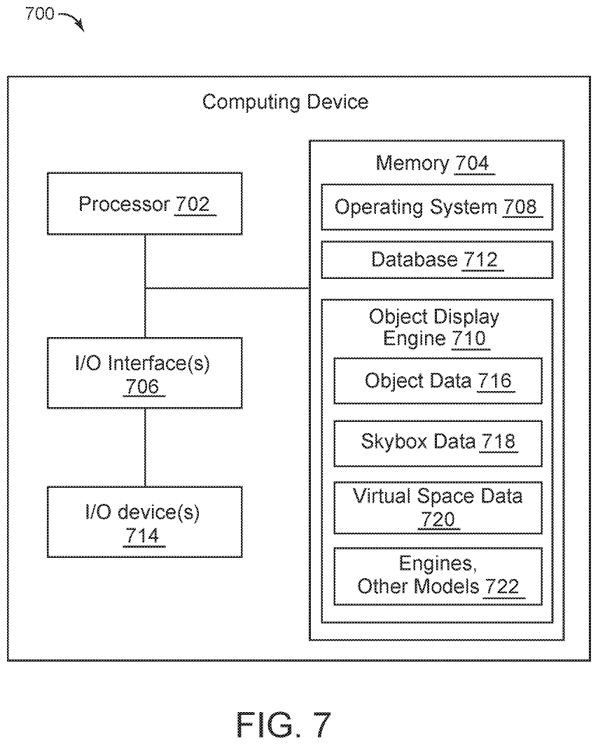

FIG. 7 is a block diagram of an example computing device 700 which may be used to implement one or more features described herein, in accordance with some implementations. In one example, device 700 may be used to implement a computer device (e.g., 72, 110, and/or 116 of FIG. 1), and perform appropriate method implementations described herein. Computing device 700 can be any suitable computer system, server, or other electronic or hardware device. For example, the computing device 700 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 700 includes a processor 702, a memory 704, input/output (I/O) interface 706, and audio/video input/output devices 714 (e.g., display screen, touchscreen, display goggles or glasses, audio speakers, microphone, etc.).

Processor 702 can be one or more processors and/or processing circuits to execute program code and control basic operations of the device 700. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, an object display engine 710, and associated data 712. In some implementations, object display engine 710 (and/or other engines) can include instructions that enable processor 702 to perform functions described herein, e.g., some or all of the methods and implementations of FIGS. 2-6B.

For example, memory 704 can include software instructions for object display engine 710 that can provide level of detail display features for virtual objects as described herein, e.g., for an online metaverse platform 102 or other device or system. Any of software in memory 704 can alternatively be stored on any other suitable storage location or computer-readable medium. Various engines, modules, instructions, machine learning models, software code, and other blocks used in described features can be stored in memory 704 and/or other connected storage devices (e.g., database 712). For example, memory 704 and/or database 712 can include caches described herein and can store data and engines for use by object display engine 710, including object data 716 (e.g., definitions, meshes, textures, attributes, etc. of 3D objects and 3D objects), skybox data 718 (e.g., definitions and attributes of skybox portions and 2D skybox objects), virtual space data 720 (e.g., size and boundaries of virtual space, specifications of various boundaries used in methods described herein, virtual camera attributes, etc.), etc. Memory 704 and/or database 712 can store. Other engines and models 722 can also be stored (e.g., for determining object interactions, movement, animations, etc.) in memory 704. Memory 704 and database 712 (and/or other connected storage device(s)) can store instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. For example, network communication devices, storage devices (e.g., memory and/or data store 108), and input/output devices can communicate via interface 706. In some implementations, the I/O interface can connect to interface devices including input devices (keyboard, gamepad or other game controller, pointing device, touchscreen, microphone, camera, scanner, etc.) and/or output devices (display device, speaker devices, printer, motor, etc.).

For ease of illustration, FIG. 7 shows one block for each of processor 702, memory 704, I/O interface 706, software blocks 708 and 710, and database 712. These blocks may represent one or more processors or processing circuitries, operating systems, memories, I/O interfaces, applications, and/or software modules. In other implementations, device 700 may not have all of the components shown and/or may have other elements including other types of elements instead of, or in addition to, those shown herein. While the online metaverse platform 102 may be described as performing operations as described in some implementations herein, any suitable component or combination of components of online metaverse platform 102 or similar system, or any suitable processor or processors associated with such a system, may perform the operations described.

A user device can also implement and/or be used with features described herein, e.g., client devices 110 and 116. Example user devices can be computer devices including some similar components as the device 700, e.g., processor(s) 702, memory 704, and I/O interface 706. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 714, for example, can be connected to (or included in) the device 700 to display images pre-and post-processing as described herein, where such display device can include any suitable display device, e.g., an LCD, LED, or plasma display screen, CRT, television, monitor, touchscreen, 3-D display screen, headset, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., methods 200, 300, and/or 500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Various implementations described herein may include processing and storing data. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., user device only; client+server device; etc.) and where the data analysis is performed (e.g., user device only; client+server device; etc.). Data are utilized for the specific purposes as described herein. No data is shared with third parties without express user permission.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
causing a graphical object to be displayed in a virtual space;
determining that the graphical object straddles a transition boundary in the virtual space, wherein the transition boundary has a location relative to a virtual camera that provides a displayed view of the virtual space; and
in response to determining that the graphical object straddles the transition boundary:
obtaining a corresponding object that is displayed with a different number of spatial dimensions than the graphical object;
placing the corresponding object at a location in the virtual space that contacts or is adjacent to the graphical object; and
causing at least a portion of the graphical object and at least a portion of the corresponding object to be displayed that are not occluded by the corresponding object or the graphical object.

2. The computer-implemented method of claim 1, further comprising:
determining that a distance between the virtual camera and the graphical object has changed in a particular direction and that the graphical object and the corresponding object are no longer straddling the transition boundary; and
in response to determining that the distance between the virtual camera and the graphical object has changed in a particular direction and that the graphical object and the corresponding object are no longer straddling the transition boundary, halting the display of the graphical object and causing the corresponding object to be displayed to represent the graphical object.

3. The computer-implemented method of claim 1, further comprising, in response to determining that the graphical object straddles the transition boundary, matching an update rate of the graphical object with an update rate of the corresponding object.

4. The computer-implemented method of claim 1, wherein the corresponding object is a corresponding three-dimensional (3D) object when the graphical object is a two-dimensional (2D) object, and the corresponding object is a corresponding 2D object when the graphical object is a 3D object.

5. The computer-implemented method of claim 4, wherein the 2D object has a lower update rate than an update rate of the 3D object.

6. The computer-implemented method of claim 1, wherein the transition boundary is shaped as at least a portion of a sphere.

7. The computer-implemented method of claim 1, wherein the graphical object is a 3D object and the corresponding object is a 2D object, and wherein obtaining the corresponding object includes generating the 2D object based on a current orientation of the 3D object at the transition boundary relative to the virtual camera.

8. The computer-implemented method of claim 1, wherein the graphical object is a 3D object and the corresponding object is a 2D object when a distance between the graphical object and the virtual camera has increased relative to a previous location of the graphical object.

9. The computer-implemented method of claim 8, wherein the 3D object includes multiple 3D objects, and further comprising, in response to determining that the graphical object straddles the transition boundary:
grouping the multiple 3D objects into a single aggregate 3D object that represents the multiple 3D objects, wherein the corresponding object is the 2D object that is generated based on the aggregate 3D object.

10. The computer-implemented method of claim 8, further comprising:
determining that the 2D object is positioned more than a threshold distance from the virtual camera;
in response to determining that the 2D object is positioned more than the threshold distance from the virtual camera:
incorporating the 2D object into a particular skybox portion that is a portion of a skybox object displayed in the virtual space; and
removing the 2D object from the virtual space.

11. The computer-implemented method of claim 10, further comprising:
caching the particular skybox portion that includes the 2D object;
retrieving one or more other previously-generated skybox portions of the skybox object from a cache; and
generating an updated skybox object for display in the virtual space, the updated skybox object including the particular skybox portion and the one or more other previously-generated skybox portions.

12. The computer-implemented method of claim 11, wherein the updated skybox object has an update rate that is lower than the update rate of the 2D object and lower than an update rate of the 3D object.

13. The computer-implemented method of claim 1, wherein the graphical object is a 2D object and the corresponding object is a 3D object, and wherein obtaining the corresponding object includes retrieving the 3D object from storage.

14. The computer-implemented method of claim 1, wherein the graphical object is a 2D object and the corresponding object is a 3D object when a distance between the graphical object and the virtual camera has decreased relative to a previous location of the graphical object.

15. The computer-implemented method of claim 1, wherein the graphical object is a second 3D object, and further comprising:
causing a first 3D object to be displayed in the virtual space in place of the second 3D object at a distance from the virtual camera below a threshold distance,
wherein causing the second 3D object to be displayed in the virtual space is performed in response to the first 3D object being positioned at greater than the threshold distance from the virtual camera, wherein the second 3D object corresponds to and replaces the first 3D object in the virtual space, and wherein the second 3D object has a lower amount of geometric complexity than the first 3D object.

16. The computer-implemented method of claim 1, further comprising:
determining a movement of the virtual camera from a first location to a second location;
determining whether the second location of the virtual camera is within a play region surrounding the virtual camera at the first location;
in response to the second location of the virtual camera being within the play region, maintaining the location of the transition boundary based on the first location of the virtual camera; and
in response to the second location of the virtual camera being at least partially outside of the play region, updating the location of the transition boundary based on the second location of the virtual camera.

17. A system comprising:
at least one processor; and
a memory coupled to the at least one processor, with software instructions stored thereon that, when executed by the at least one processor, cause the at least one processor to perform operations including:
causing a 3D object to be displayed in a virtual space;
determining that the 3D object straddles a transition boundary in the virtual space, wherein the transition boundary has a location relative to a virtual camera that provides a displayed view of the virtual space;
in response to determining that the 3D object straddles the transition boundary:
generating a 2D object corresponding to the 3D object;
placing the 2D object in the virtual space at the transition boundary and contacting or adjacent to the 3D object;
causing at least a portion of the 3D object that is not occluded by the 2D object to be displayed; and
causing a first portion of the 2D object that is not occluded by the 3D object to be displayed, wherein a second portion of the 2D object is occluded by the 3D object and is not displayed.

18. The system of claim 17, wherein the 3D object has a first update rate that is the same as a second update rate of the 2D object.

19. A non-transitory computer-readable medium with instructions stored thereon that, when executed by a processor, cause the processor to perform operations comprising:
causing a 2D object to be displayed in a virtual space;
determining that the 2D object straddles a transition boundary in the virtual space, wherein the transition boundary has a location relative to a virtual camera that provides a displayed view of the virtual space;
in response to determining that the 2D object straddles the transition boundary:
obtaining a 3D object corresponding to the 2D object;
placing the 3D object in the virtual space at the transition boundary and contacting or adjacent to the 2D object;
causing at least a portion of the 3D object that is not occluded by the 2D object to be displayed; and
causing a first portion of the 2D object that is not occluded by the 3D object to be displayed, wherein a second portion of the 2D object is occluded by the 3D object and is not displayed.

20. The computer-readable medium of claim 19, wherein the 3D object has a first update rate that is the same as a second update rate of the 2D object.
